(19) United States
(12) Patent Application Publication
(10) Pub. No.: US 2023/0365427 A1
(43) Pub. Date: Nov. 16, 2023

(54) NANOPORCUPINE, METHOD OF MANUFACTURE AND USE THEREOF

(71) Applicant: INSTITUT NATIONAL DE LA RECHERCHE SCIENTIFIQUE, Québec (CA)

(72) Inventors: Amir HASSANPOUR, Montreal (CA); Marc A. GAUTHIER, St-Bruno-de-Montarville (CA); Shuhui SUN, Ste-Julie (CA); Marie-Christine GROLEAU, Laval (CA); Eric DEZIEL, Rosemère (CA)

(21) Appl. No.: 18/312,665

(22) Filed: May 5, 2023

Related U.S. Application Data
(60) Provisional application No. 63/364,669, filed on May 13, 2022.

(51) Int. Cl. C01G 9/02; C08K 3/22; C09D 5/14

(52) U.S. Cl. CPC C01G 9/02; C08K 3/22; C09D 5/14; C01P 2004/64; C08K 2003/2296; C01P 2002/74; C01P 2002/01; C01P 2002/80; C01P 2004/13; C08K 2201/011

(57) ABSTRACT

We provide ZnO nanoporcupines and a coating comprising ZnO nanoporcupines. Each nanoporcupine comprises a ZnO stem attached by one end to said surface, and a plurality of ZnO nanospikes attached to and extending away from the surface of the stem, the nanospikes being spread across the surface of the stem. The nanoporcupines and coating have antibacterial properties. We also provide a method of producing the nanoporcupine/coating comprising the steps of immersing a surface with ZnO stem precursors in a reaction mixture comprising hexamethylenetetramine, up to about 1 mM of L-ascorbic acid, and up to about 1 mM of a zinc salt in deionized water, and heating the reaction mixture at a temperature between about 90° C. and about 95° C. to produce the ZnO nanoporcupines on the surface.

### CROSS-REFERENCE TO RELATED APPLICATIONS

This application claims benefit, under 35 U.S.C. § 119(e), of U.S. provisional application Ser. No. 63/364,669, filed on May 13, 2022.

### FIELD OF THE INVENTION

The present invention relates to a new ZnO nanostructure. More specifically, the present invention is concerned with ZnO nanoporcupines as well as a coating comprising these ZnO nanoporcupines.

### BACKGROUND OF THE INVENTION

Bacterial antimicrobial resistance was associated with almost 4.95 million deaths in 2019 [1]. Recent estimations suggest that antimicrobial resistance is an issue on the scale of major diseases, such as HIV and malaria. Furthermore, it is estimated that around 10 million people could die in high-income countries by 2050 without a sustained effort to stem antimicrobial resistance [2]. To tackle this problem, different actions have been suggested, such as widespread vaccination. However, priority must be given to the preventive measures to reduce the spread and duplication of dangerous pathogens. Such measures will significantly lower the chance that pathogens infect a person in the first place.

One of the most common ways that pathogens spread is by contact with a contaminated surface. Analysis shows that some pathogenic bacteria can live up to a couple of months on certain surfaces [3]. This problem is more critical in crowded areas where traditional disinfection methods are limited to a certain number of applications per day. Door handles and lift buttons are examples of surfaces that are touched by many individuals between each round of cleaning. Controlling antibiotic-resistant bacteria in hospitals is another major challenge [4]. Healthcare-associated infection (HAI) is a common cause of death or longer hospitalization for patients who stay in highly restricted areas like intensive care units (ICUs). For instance, certain types of bacteria spread from the washing sink to the patient's bed, which is located in its vicinity [5]. Nosocomial infections can be deadly since some patients are already immunocompromised. Treating these infections can be challenging with the emergence of antibiotic-resistant bacteria in the hospital environment [6].

Disinfection of common surfaces is one way of limiting the transmission of pathogens in populated areas [7]. Strong disinfectants are available in different formats (liquid, spray) for different surfaces and applications. Liquid disinfecting agents are classified into three main groups according to their relative toxicity to patients and health care personnel [8]. For instance, the ‘severe’ group of disinfectants is harmful to the people who are exposed to them, and yet some bacterial spores (such as Bacillus) tolerate these substances [9].

A safer, more effective, and complementary strategy to mitigate the spread of pathogens on surfaces is to use multifunctional antibacterial surface coatings. However, these have had limited use so far. In practice, micro-patterned surfaces can repel bacteria rather than kill/damage them by manipulating surface tension (e.g., Sharklet Technologies Inc.) [10]. Such technologies have been used on catheters to reduce the potential for developing urinary tract infections. Other coatings contain agents that are claimed to electrostatically attract and damage pathogens (e.g. MicroShield 360™) [11]. This technology has been used in some residential applications and more recently in the aviation industry. Finally, light-activated antibacterial coatings based on titanium dioxide equally exist and are suitable for transparent surfaces (Kastus® Coating Technology) [12]. These technologies all present shortcomings, including the use of harsh chemicals and/or complex deposition systems for their fabrication, limited durability, etc.

### SUMMARY OF THE INVENTION

In accordance with the present invention, there is provided:

EMBODIMENT 1: ZnO nanoporcupines comprising:
a ZnO stem, wherein the ZnO stem is an elongated ZnO nanostructure or microstructure, and
a plurality of ZnO nanospikes attached to and extending away from the surface of the stem, the nanospikes being spread along the length and the circumference of the stem.

EMBODIMENT 2: The ZnO nanoporcupines of embodiment 1, being attached to a surface of a substrate.

EMBODIMENT 3: A coating on a surface of a substrate, the coating comprising ZnO nanoporcupines attached to said surface, wherein each nanoporcupine comprises:
a ZnO stem attached by one end to said surface, wherein the ZnO stem is an elongated ZnO nanostructure or microstructure, and
a plurality of ZnO nanospikes attached to and extending away from the surface of the stem, the nanospikes being spread across the surface of the ZnO stem.

EMBODIMENT 4: The ZnO nanoporcupines/coating of embodiment 2 or 3, wherein the ZnO stem extends away from said surface.

EMBODIMENT 5: The ZnO nanoporcupines/coating of any one of embodiments 1 to 4, wherein the ZnO stem has a wurtzite crystal structure, typically grown along its c axis of the nanoneedle.

EMBODIMENT 6: The ZnO nanoporcupines/coating of any one of embodiments 1 to 5, wherein the ZnO stem has length/diameter ratio of about 120 to about 2, preferably about 30 to about 3, and more preferably about 7.

EMBODIMENT 7: The ZnO nanoporcupines/coating of any one of embodiments 1 to 6, the ZnO stem has an average length of about 30 nm to about 6 μm, preferably about 50 nm to about 3 μm, more preferably about 300 nm to about 1 μm, yet more preferably about 100 nm to about 1 μm, and most preferably of about 810 nm.

EMBODIMENT 8: The ZnO nanoporcupines/coating of any one of embodiments 1 to 7, the ZnO stem has an average diameter or width of about 20 nm to about 1 μm, preferably about 20 nm to about 700 nm, more preferably about 20 nm to about 100 nm, and most preferably of about 50 nm.

EMBODIMENT 9: The ZnO nanoporcupines/coating of any one of embodiments 1 to 8, wherein the nanoneedle has a hexagonal cross-section.

EMBODIMENT 10: The ZnO nanoporcupines/coating of any one of embodiments 1 to 9, wherein the ZnO stem is a ZnO nanoneedle, a ZnO microneedle, or a ZnO nanotube.

EMBODIMENT 11: The ZnO nanoporcupines/coating of any one of embodiments 1 to 10, wherein the ZnO stem is tapered.

EMBODIMENT 12: The ZnO nanoporcupines/coating of embodiment 11, wherein the ZnO stem is a ZnO nanoneedle or a ZnO microneedle.

EMBODIMENT 13: The ZnO nanoporcupines/coating of embodiment 12, wherein the ZnO stem is a ZnO nanoneedle.

EMBODIMENT 14: The ZnO nanoporcupines/coating of embodiment 13, wherein the ZnO nanoneedle has an average length of about 50 nm to about 3 μm, preferably about 300 nm to about 1 μm, more preferably about 100 nm to about 1 μm, and most preferably of about 810 nm.

EMBODIMENT 15: The ZnO nanoporcupines/coating of embodiments 13 or 14, wherein the ZnO nanoneedle has an average diameter or width of about 20 nm to about 700 nm, preferably about 20 nm to about 100 nm, and most preferably of about 50 nm.

EMBODIMENT 16: The ZnO nanoporcupines/coating of embodiment 12, wherein the ZnO stem is a ZnO microneedle.

EMBODIMENT 17: The ZnO nanoporcupines/coating of embodiment 16, wherein the ZnO microneedle has an average length of at least about 4 μm, preferably at least about 3 μm, and most preferably at least about 1.5 μm.

EMBODIMENT 18: The ZnO nanoporcupines/coating of embodiment 16 or 17, wherein the ZnO microneedle has an average diameter or width of more than about 700 nm and preferably up to about 2 μm, more preferably about up to 1 μm, and most preferably of about 0.5 μm.

EMBODIMENT 19: The ZnO nanoporcupines/coating of any one of embodiments 1 to 10, wherein the ZnO stem is non-tapered.

EMBODIMENT 20: The ZnO nanoporcupines/coating of embodiment 19, wherein the ZnO stem is a ZnO nanotube.

EMBODIMENT 21: The ZnO nanoporcupines/coating of embodiment 20, wherein the ZnO nanotube has an average length of up to about 3 μm, preferably up to about 1 μm, and most preferably of about 0.8 μm.

EMBODIMENT 22: The ZnO nanoporcupines/coating of embodiment 20 or 21, wherein the ZnO nanotube has an average diameter or width up to about 500 nm, preferably up to about 100 nm, and most preferably of about 50 nm.

EMBODIMENT 23: The ZnO nanoporcupines/coating of any one of embodiments 1 to 22, wherein the nanospikes are spread across the whole surface of the nanoneedle.

EMBODIMENT 24: The ZnO nanoporcupines/coating of any one of embodiments 1 to 23, wherein the in the nanospikes has a wurtzite crystal structure, preferably grown perpendicular to the c axis of the nanospikes.

EMBODIMENT 25: The ZnO nanoporcupines/coating of any one of embodiments 1 to 24, wherein the nanospikes have a spheroidal cross-section.

EMBODIMENT 26: The ZnO nanoporcupines/coating of any one of embodiments 1 to 25, wherein the nanospikes have an average length at least about 2, at least about 2.5, at least about 3 times their average diameter.

EMBODIMENT 27: The ZnO nanoporcupines/coating of any one of embodiments 1 to 26, wherein the nanospikes have an average length of about 5 nm to about 100 nm, preferably about 10 nm to about 20 nm, and most preferably of about 13 nm.

EMBODIMENT 28: The ZnO nanoporcupines/coating of any one of embodiments 1 to 27, wherein the nanospikes have an average diameter or width of about 2 nm to about 20 nm, preferably about 3 nm to about 10 nm, and most preferably of about 5 nm.

EMBODIMENT 29: The ZnO nanoporcupines/coating of any one of embodiments 1 to 14, wherein the nanoporcupines are densely packed on the surface of the substrate, preferably the spacing between each neighboring nanoporcupine is less than about 5 nm at their base, the base of the nanoporcupine being the 28 of attachment of the ZnO nanoneedle to the surface.

EMBODIMENT 30: The ZnO nanoporcupines/coating of embodiment 29, wherein the nanoporcupines are in contact with one another at their base.

EMBODIMENT 31: The ZnO nanoporcupines/coating of any one of embodiments 1 to 30, having a XRD pattern exhibiting a peak at about 34.52 having a full width at half maximums (FWHMs) of less than about 0.2, preferably less than about 1.9, more preferably less than about 0.8, and most preferably of about 0.1742.

EMBODIMENT 32: The ZnO nanoporcupines/coating of any one of embodiments 1 to 31, wherein the nanospikes have a lattice spacing of about 0.52 nm, as measured in a HRTEM image of the nanospike.

EMBODIMENT 33: The ZnO nanoporcupines/coating of any one of embodiments 1 to 32, having a photoluminescence spectrum exhibiting a near band edge emission (NBE) of ZnO crystals at about 377 nm.

EMBODIMENT 34: The ZnO nanoporcupines/coating of any one of embodiments 1 to 33, wherein the nanoporcupines bear surface hydroxyl groups.

EMBODIMENT 35: The ZnO nanoporcupines/coating of any one of embodiments 1 to 34, wherein the nanoporcupines bear surface oxygen atoms in the following proportion:
about 35% or less (and preferably no less than about 15%) of O²⁻ ions in a stoichiometric ratio with Zn²⁺ and, preferably about 30% or less (and preferably no less than about 20%) of O²⁻ ions in a stoichiometric ratio with Zn²⁺, and most preferably about 25% (e.g. 25.47%) of O²⁻ ions in a stoichiometric ratio with Zn²¹, and/or
about 65% or more (and preferably no more than about 85%) of O²⁻ ions in an oxygen-deficient ZnOₓ region or to hydroxyl groups, about 70% or more (and preferably no more than about 80%) of O²⁻ ions in an oxygen-deficient ZnOₓ region or to hydroxyl groups, and about 75% (e.g., 74.53%) of O²⁻ ions in an oxygen-deficient ZnOₓ region or to hydroxyl groups,
as measured by curve fitting the O_{L} and O_{H} peaks of a high-resolution XPS spectrum of the nanoporcupines.

EMBODIMENT 36: The ZnO nanoporcupines/coating of any one of embodiments 1 to 35, having a contact angle of more than about 55°, preferably more than about 65°, more preferably more than about 75°, yet more preferably more than about 85°, and most preferably of about more than about 890 (e.g. 88.7°), as measured by placing a 5 μL water droplet on a coating of the nanoporcupines on a stainless steel substrate.

EMBODIMENT 37: Use of the nanoporcupines of any one of embodiments 1, 2 and 4 to 36 to form an antibacterial coating for a surface.

EMBODIMENT 38: A method of conferring antibacterial properties to a surface, the method comprising the step of attaching the nanoporcupines of any one of embodiments 1, 2 and 4 to 36 on said surface, and

EMBODIMENT 39: Use of the coating of any one of embodiments 3 to 36 as an antibacterial coating for a surface.

EMBODIMENT 40: A method of conferring antibacterial properties to a surface, the method comprising the step of adding the coating of any one of embodiments 3 to 36 to the surface.

EMBODIMENT 41: Use of the nanoporcupines of any one of embodiments 1, 2 and 4 to 36 to form an antiviral coating for a surface.

EMBODIMENT 42: A method of conferring antiviral properties to a surface, the method comprising the step of attaching the nanoporcupines of any one of embodiments 1, 2 and 4 to 36 on said surface, and

EMBODIMENT 43: Use of the coating of any one of embodiments 3 to 36 as an antiviral coating for a surface.

EMBODIMENT 44: A method of conferring antiviral properties to a surface, the method comprising the step of adding a coating of any one of embodiments 3 to 36 to the surface.

EMBODIMENT 45: The nanoporcupines/coating/use and method of any one of embodiments 2 to 44, wherein the surface is flat.

EMBODIMENT 46: The nanoporcupines/coating/use and method of any one of embodiments 2 to 45, wherein the surface is made of a material that can be annealed at a temperature of at least 200° C.

EMBODIMENT 47: The nanoporcupines/coating/use and method of any one of embodiments 2 to 46, wherein the surface is a surface that does not remain immersed in water for extended periods of time during normal use.

EMBODIMENT 48: The nanoporcupines/coating/use and method of any one of embodiments 2 to 47, wherein the surface is a surface in a public area, such as a surface of a door handle, a lift button, or a hospital equipment (e.g., a sink).

EMBODIMENT 49: The nanoporcupines/coating/use and method of any one of embodiments 2 to 48, wherein the surface is a surface of a sanitary pipe.

EMBODIMENT 50: A method of producing the nanoporcupine/coating of any one of embodiments 1 to 36, the method comprising the steps of:
providing ZnO stem precursors, attached by one end to a surface of a substrate and extending away from said surface, and
providing a reaction mixture in a reaction container, wherein the reaction mixture comprises hexamethylenetetramine, up to about 1 mM of L-ascorbic acid, and up to about 1 mM of a zinc salt in deionized water,
immersing the surface with the ZnO stem precursors in the reaction mixture, and
heating the reaction mixture at a temperature between about 90° C. and about 95° C. to produce the ZnO nanoporcupines on the surface.

EMBODIMENT 51: The method of embodiment 50, wherein the zinc salt is zinc nitrate, zinc acetate, zinc chlorate, or zinc sulfate, preferably zinc nitrate and/or zinc acetate.

EMBODIMENT 52: The method of embodiment 50 or 51, wherein the reaction mixture has a zinc salt concentration of about 0.1 mM to about 5 mM, preferably from about 0.1 mM to about 1 mM, more preferably of about 0.7 mM.

EMBODIMENT 53: The method of any one of embodiments 50 to 52, wherein the reaction mixture has a hexamethylenetetramine concentration of about 0.1 mM to about 1 mM, preferably from about 0.1 mM to about 1 mM, more preferably of about 0.7 mM.

EMBODIMENT 54: The method of any one of embodiments 50 to 52, wherein the HMTA:zinc salt weight ratio is from about 1:3 to about 3:1, preferably about 1:1.

EMBODIMENT 55: The method of any one of embodiments 50 to 54, wherein the reaction mixture has a L-ascorbic acid concentration of about 0.1 mM to about 1 mM, preferably from about 0.1 mM to about 0.7 mM, more preferably of about 0.4 mM.

EMBODIMENT 56: The method of any one of embodiments 50 to 55, wherein step B comprises the step of providing a solution of the zinc salt and the L-ascorbic acid in deionized water and then adding the hexamethylenetetramine to the solution of the zinc salt and the L-ascorbic acid.

EMBODIMENT 57: The method of any one of embodiments 50 to 56, wherein, during steps C and D, the surface lies mid-water in the reaction container.

EMBODIMENT 58: The method of any one of embodiments 50 to 57, wherein the surface on which the ZnO stem precursors are to be grown is at an angle Θ from the bottom of the reaction contained, preferably the angle Θ is between 0° and 90°, and more preferably at 45°.

EMBODIMENT 59: The method of any one of embodiments 50 to 58, wherein, in step E), the reaction mixture is heated of about 90° C.

EMBODIMENT 60: The method of any one of embodiments 50 to 59, wherein, in step E), the reaction mixture is heated for about 2 to about 8 hours, preferably for about 4 h e.g., in a furnace.

### BRIEF DESCRIPTION OF DRAWINGS

In the appended drawings:

FIG. 1 shows schemes of A) ZnO nanorod, B) a ZnO nanoneedle, and C) a ZnO nanoporcupine.

FIG. 2 shows the position of the surface on which the nanorods are to be grown in the reaction container Schemes of A)

FIG. 3 shows top-view Scanning Electron Microscopy (SEM) images of ZnO thin film (TF) deposited by magnetron sputtering.

FIG. 4 shows top-view SEM images of ZnO nanorods (NR) with flat tops A) at low magnification and B) at high magnification.

FIG. 5 shows top-view SEM images of ZnO nanoneedles (NN) A) at low magnification and B) at high magnification.

FIG. 6 shows top-view SEM images of ZnO nanoporcupine (NP) according to the invention A) at low magnification and B) at high magnification. C) TEM of ZnO nanoporcupine grown on the stem of a microneedle laying down on a stainless steel substrate.

FIG. 7 shows the X-ray diffraction (XRD) patterns of ZnO TF, NR, NN, and NP. These diffractograms show the formation of ZnO wurtzite nanostructure with preferential (002) crystal orientation. The Cu peaks represent the presence of trace copper in the S.S. substrate

FIG. 8 shows the Transmission Electron Microscopy (TEM) image of the nanoporcupine (NP).

FIG. 9 shows the room temperature photoluminescence spectra of ZnO TF, NR, NN, and NP.

FIG. 10 shows the X-ray photoelectron spectroscopy (XPS) spectra of ZnO TF, NR, NN, and NP.

FIG. 11 shows the deconvolution of the O 1s peaks of ZnO TF, NNs, NPs, and NRs of ZnO TF, NR, NN, and NP.

FIG. 12 shows the contact angle formed by 5 μL of water droplet on ZnO coatings with different topologies. Data presented as average±SD (n=4)

FIG. 13 shows the concentration of bacteria recovered after 1-h contact with the samples. S. aureus strain Newman, without humidity control. t=0: initial bacterial concentration of the suspension placed on the surfaces, S.S. TF, NP, NR, and NN. The limit of detection of the method was 10² CFU/mL. The error bars represent standard deviation from the mean (n=5 independent coupons). “****” denotes a statistically significant difference p<0.0005), “***” denotes a statistically significant difference p<0.005), ns: non-significant (ANOVA with Tukey's multiple-comparison test).

FIG. 14 shows the concentration of bacteria recovered after 1-h contact with the samples. S. aureus strain Newman, with humidity control. t=0: initial bacterial concentration of the suspension placed on the surfaces, S.S. TF, NP, NR, and NN. The limit of detection of the method was 10² CFU/mL. The error bars represent standard deviation from the mean (n=5 independent coupons). “****” denotes a statistically significant difference p<0.0005), “***” denotes a statistically significant difference p<0.005), ns: non-significant (ANOVA with Tukey's multiple-comparison test).

FIG. 15 shows the concentration of bacteria recovered after 1-h contact with the coatings. K. pneumoniae ATCC 4352, without humidity control. t=0: initial bacterial concentration of the suspension placed on the surfaces, S.S. TF, NP, NR, and NN. The limit of detection of the method was 10² CFU/mL. The error bars represent standard deviation from the mean (n=5 independent coupons). Value for all NR coupons was under 10⁻² CFU/mL. Data points not visible on the graph represent values under 10⁻². “****” denotes a statistically significant difference (ANOVA with Tukey's multiple-comparison test p<0.0005).*

FIG. 16 shows the concentration of bacteria recovered after 1-h contact with the coatings. K. pneumoniae ATCC 4352, with humidity control. t=0: initial bacterial concentration of the suspension placed on the surfaces, S.S. TF, NP, NR, and NN. The limit of detection of the method was 10² CFU/mL. The error bars represent standard deviation from the mean (n=5 independent coupons). Value for all NR coupons was under 10⁻² CFU/mL. Data points not visible on the graph represent values under 10⁻². “****” denotes a statistically significant difference (ANOVA with Tukey's multiple-comparison test p<0.0005).

FIG. 17 is a SEM image of the product obtained in Comparative Example 1.

FIG. 18 is a SEM image of the product obtained in Comparative Example 2.

FIG. 19 is a scheme of the water cross-flow setup used in Example 3.

FIG. 20 is a SEM image of the nanoporcupines after 6 hours of water cross-flow test.

FIG. 21 is a SEM image of the nanoporcupines after the brush test.

### DETAILED DESCRIPTION OF THE INVENTION

Turning now to the invention in more details, there is provided ZnO nanoporcupines as well as a coating comprising these ZnO nanoporcupines.

The nanoporcupines/coating of the invention exhibits bactericidal properties towards Gram-positive (S. aureus) and Gram-negative bacteria (K. pneumonia). Therefore, there is also provided here
the use of the nanoporcupines of the invention to form an antibacterial coating for a surface and a method of conferring antibacterial properties to a surface, the method comprising the step of attaching nanoporcupines on said surface, and
the use of the coating of the invention as an antibacterial coating for a surface and a method of conferring antibacterial properties to a surface, the method comprising the step of adding a coating of the invention to the surface.

It is also expected that the nanoporcupines/coating of the invention will exhibit antiviral activity. Therefore, there is also provided here
the use of the nanoporcupines of the invention to form an antiviral coating for a surface and a method of conferring antiviral properties to a surface, the method comprising the step of attaching nanoporcupines on said surface, and
the use of the coating of the invention as an antiviral coating for a surface and a method of conferring antiviral properties to a surface, the method comprising the step of adding a coating of the invention to the surface.

The nanoporcupines/coating of the invention can be used on practically all surfaces. The surface can be flat or curved for as long as it has an identifiable front and an identifiable back of the surface (for instance spherical bids or round doorknobs are not suitable). In preferred embodiments however, the surface is flat Also, in preferred embodiments, the surface is made of a material that can be annealed at a temperature of at least 200° C. In preferred embodiments, the surface is a surface that does not remain immersed in water for extended periods of time during normal use.

In embodiments, the surface is a surface in a public area, such as a surface of a door handle, a lift button, or a hospital equipment (e.g. a sink). In embodiments, the surface is an inner surface of a sanitary pipe.

The nanoporcupines/coating of the invention offers acceptable resistance against commonly used cleaning agents and physical stress.

Finally, the nanoporcupines/coating of the invention is bio-friendly.

Nanoporcupines and Coatings of the Invention

Turning now to the invention in more details, there are provided ZnO nanoporcupines comprising:
a ZnO stem, wherein the ZnO stem is an elongated ZnO nanostructure or microstructure, and
a plurality of ZnO nanospikes attached to and extending away from the surface of the stem, the nanospikes being spread along the length and the circumference of the stem.

In preferred embodiments, the ZnO nanoporcupines are attached to a surface of a substrate. In preferred such embodiments, the ZnO stem of the ZnO nanoporcupine is attached by one end to said surface. More preferably, the ZnO stem of the ZnO nanoporcupine extends away from said surface.

Thus, in a related aspect of the invention, there is also provided a coating on a surface of a substrate, the coating comprising ZnO nanoporcupines attached to said surface, wherein each nanoporcupine comprises:
a ZnO stem attached by one end to said surface, wherein the ZnO stem is an elongated ZnO nanostructure or microstructure, and
a plurality of ZnO nanospikes attached to and extending away from the surface of the stem, the nanospikes being spread across the surface of the ZnO stem.

In preferred embodiments, the surface of the substrate is the surface defined in the previous section. Also, in preferred embodiment, the stem of the ZnO nanoporcupines extends away from said surface.

The ZnO nanoporcupines of the invention are a new ZnO nanostructure, different from other known nanostructures such as ZnO nanoneedles, microneedles, nanorods, nanowires, nanotubes, and nanoarrays.

In preferred embodiments, the ZnO stem has length/diameter ratio of about 120 to about 2, preferably about 30 to about 3, and more preferably about 7.

In preferred embodiments, the ZnO stem has a wurtzite crystal structure, typically grown along its c axis of the nanoneedle.

In preferred embodiments, the ZnO stem is a ZnO nanoneedle, a ZnO microneedle, or a ZnO nanotube.

In preferred embodiments, the ZnO stem is tapered. Non-limiting examples of tapered stems include ZnO nanoneedles and ZnO microneedles.

In preferred embodiments, the ZnO stem is non-tapered. Non-limiting examples of non-tapered stems include ZnO nanotubes.

In preferred embodiments, the ZnO stem is a ZnO nanoneedle.

Herein, “ZnO nanoneedles”, “ZnO microneedles”, “ZnO nanorods”, “ZnO nanowires”, “ZnO nanotubes”, and “ZnO nanoarrays” have their regular meaning in the art. For more certainty:
a ZnO nanoneedle is a tapered ZnO nanorod, ZnO nanowire, or ZnO nanoarray, with a wurtzite crystal structure, typically grown along their c axis of the nanoneedle—nanoneedles are nanometric in size;
a ZnO nanorod is a nanosized rod of ZnO, also with a wurtzite crystal structure, which is also typically grown along the c axis of the nanorod, typically non-tapered, often having generally flat ends and typically having a length/width ratio of at least about 2 and at most about 10;
ZnO microrod and microneedle is the same as a ZnO nanorod and nanoneedle, respectively, except that they are micrometric in size (the microneedle being made from microrods rather than nanorods/nanowires/nanoarrays;
a ZnO nanowire is the same as a ZnO nanorod, except that it is longer, typically having a length/width ratio of more than about 10;
a ZnO nanotube is the same as a ZnO nanorod, except that the inside of the nanorod has been etched to form a tube; and
a ZnO nanoarrays is the same as a collection of ZnO nanorods, with the added limitation that the nanorods are arranged perpendicularly on a surface.

As well known to the skilled person, the “c axis” of the nanoneedles, nanorods, and other elongated structures (and hence the ZnO stem) is their longitudinal axis. FIG. 1 shows schemes of A) ZnO nanorod showing the c axis, B) a ZnO nanoneedle, and C) a ZnO nanoporcupine.

The ZnO stem in the nanoporcupine (and coating) of the invention comprises, as per the above definition, ZnO with a wurtzite crystal structure, preferably grown along the c axis of the stem.

In preferred embodiments, the ZnO stem consists of ZnO with a wurtzite crystal structure, preferably grown along the c axis of the ZnO stem.

The ZnO stem can have cross section of any shape. In preferred embodiments, the ZnO stem has a hexagonal cross-section.

In preferred embodiments, the ZnO stem has an average length of about 30 nm to about 6 μm, preferably about 50 nm to about 3 μm, more preferably about 300 nm to about 1 μm, yet more preferably about 100 nm to about 1 μm, and most preferably of about 810 nm.

In preferred embodiments, the ZnO stem has an average diameter or width of about 20 nm to about 1 μm, preferably about 20 nm to about 700 nm, more preferably about 20 nm to about 100 nm, and most preferably of about 50 nm.

In embodiments, the ZnO stem is a ZnO nanoneedle. In preferred such embodiments, the ZnO nanoneedle has an average length of about 50 nm to about 3 μm, preferably about 300 nm to about 1 μm, more preferably about 100 nm to about 1 μm, and most preferably of about 810 nm. In preferred such embodiments, the ZnO nanoneedle has an average diameter or width of about 20 nm to about 700 nm, preferably about 20 nm to about 100 nm, and most preferably of about 50 nm. In preferred such embodiments, the ZnO nanoneedle has a hexagonal cross-section.

In embodiments, the ZnO stem is a ZnO microneedle. In preferred such embodiments, the ZnO microneedle has an average length of at least about 4 μm, preferably at least about 3 μm, and most preferably at least about 1.5 μm. In preferred such embodiments, the ZnO microneedle has an average diameter or width of more than about 700 nm and preferably up to about 2 μm, more preferably about up to 1 μm, and most preferably of about 0.5 μm.

In embodiments, the ZnO stem is a ZnO nanotube. In preferred such embodiments, the ZnO nanotube has an average length of up to about 3 μm, preferably up to about 1 μm, and most preferably of about 0.8 μm. In preferred such embodiments, the ZnO nanotube has an average diameter or width up to about 500 nm, preferably up to about 100 nm, and most preferably of about 50 nm.

As noted above, the nanoporcupine comprises a plurality of ZnO nanospikes. Herein, a “ZnO nanospike” is an elongated nanosized protrusion of ZnO. In preferred embodiments, the ZnO nanospikes have a tapered tip.

The ZnO nanospikes are spread across the surface of the ZnO stem in no particular pattern or order. Also, some nanospikes may be apart from one another, while other are touching each other. In preferred embodiments, the ZnO nanospikes are spread across the whole surface of the ZnO stem.

Herein, the word “attached”, as in the ZnO stem attached to a surface and the plurality of ZnO nanospikes attached to the surface of the ZnO stem simply, has no implication as to how the nanoporcupine have been manufactured. It simply denotes the connection between the elements involved.

In preferred embodiments, the ZnO in the nanospikes has a wurtzite crystal structure, preferably grown perpendicular to the c axis of the nanospikes. In more preferred embodiments, the ZnO nanospikes consists of ZnO with a wurtzite crystal structure, preferably grown perpendicular to the c axis of the nanospikes.

The ZnO nanospikes can have cross section of any shape. In preferred embodiments, the ZnO nanospikes have a spheroidal cross-section.

In preferred embodiments, the ZnO nanospikes have an average length at least about 2, at least about 2.5, at least about 3 times their average diameter.

In preferred embodiments, the ZnO nanospikes have an average length of about 5 nm to about 100 nm, preferably about 10 nm to about 20 nm, and most preferably of about 13 nm.

In preferred embodiments, the ZnO nanospikes have an average diameter or width of about 2 nm to about 20 nm, preferably about 3 nm to about 10 nm, and most preferably of about 5 nm.

Herein, “extending away”, as in the ZnO stem extending away from the surface of the substrate and the ZnO nanospikes extending away from the surface of the ZnO stem, should not be understood that the stems or nanospikes, as the case may be, must be exactly perpendicular to the surface they extend from. Rather, the stems/nanospikes can be at an angle, see e.g. the SEM and TEM images herein. Furthermore, while the nanoporcupines of the invention comprise ZnO stems extending away from the surface of the substrate with ZnO nanospikes extending away from the surface of the stem, it is not excluded that it may also comprise some ZnO stems lying (or almost lying) on the surface of the substrate and/or some ZnO nanospikes lying (or almost lying) on the surface of the stem.

In preferred embodiments, the nanoporcupines are densely packed on the surface of the substrate, preferably the spacing between each neighboring nanoporcupine is less than about 5 nm at their base, the base of the nanoporcupine being the point of attachment of the ZnO stem to the surface. In yet more preferred embodiments, the nanoporcupines are in contact with one another at their base.

In preferred embodiments, the nanoporcupine/coating of the invention have a XRD pattern exhibiting a peak at about 34.52 having a full width at half maximums (FWHMs) of less than about 0.2, preferably less than about 1.9, more preferably less than about 0.8, and most preferably of about 0.1742. This peak is attributed to the ZnO (002) peak and is representative of crystal growth along the c axis of wurtzite ZnO. Of note, XRD does not discriminate between the ZnO stem and the nanospikes and, since the nanospikes are much smaller than the ZnO stem, thus provides information about the crystal structure of the ZnO stem only.

In preferred embodiments, the nanospikes in the nanoporcupines of the invention have a lattice spacing of about 0.52 nm, as measured in a HRTEM image of the nanospike.

In preferred embodiments, the nanoporcupine/coating of the invention have a photoluminescence spectrum exhibiting a near band edge emission (NBE) of ZnO crystals at about 377 nm.

In preferred embodiments, the nanoporcupines of the invention bear surface hydroxyl groups.

In preferred embodiments, the nanoporcupines of the invention bear surface oxygen atoms in the following proportion:
about 35% or less (and preferably no less than about 15%) of O²⁻ ions in a stoichiometric ratio with Zn²⁺ and
about 65% or more (and preferably no more than about 85%) of O²⁻ ions in an oxygen-deficient ZnOₓ region or to hydroxyl groups,
preferably about 30% or less (and preferably no less than about 20%) of O²⁻ ions in a stoichiometric ratio with Zn²⁺, and
about 70% or more (and preferably no more than about 80%) of O²⁻ ions in an oxygen-deficient ZnOₓ region or to hydroxyl groups, and
most preferably about 25% (e.g. 25.47%) of O²⁻ ions in a stoichiometric ratio with Zn²⁺ and
about 75% (e.g., 74.53%) of O²⁻ ions in an oxygen-deficient ZnOₓ region or to hydroxyl groups,
as measured by curve fitting the O_{L} and O_{H} peaks of a high-resolution XPS spectrum of the nanoporcupines.

The nanoporcupine/coating of the invention have a contact angle of more than about 55°, preferably more than about 65°, more preferably more than about 75°, yet more preferably more than about 85°, and most preferably of about more than about 890 (e.g. 88.7°), as measured by placing a 5 μL water droplet on a coating of the nanoporcupines on a stainless steel substrate.

### Method of Manufacture

In another related aspect, there is provided a method of producing the nanoporcupine/coating of the invention. This method comprises the steps of:
STEP A. providing ZnO stem precursors, attached by one end to a surface of a substrate and extending away from said surface, and
STEP B. providing a reaction mixture in a reaction container, wherein the reaction mixture comprises hexamethylenetetramine, up to about 1 mM of L-ascorbic acid, and up to about 1 mM of a zinc salt in deionized water,
STEP C. immersing the surface with the ZnO stem precursors in the reaction mixture, and
STEP D. heating the reaction mixture at a temperature between about 90° C. and about 95° C. to produce the ZnO nanoporcupines on the surface.

In preferred embodiments, the surface of the substrate is the surface defined in the two previous sections.

Non-limiting examples of ZnO stem precursors include ZnO nanoneedles, ZnO microneedles, ZnO nanorods, ZnO microrods, ZnO nanowires, ZnO nanotubes, and ZnO nanoarrays.

ZnO nanorods will be etched in step D and thus yield nanoporcupines with a ZnO stem that is a nanoneedle.

ZnO nanoneedles, ZnO nanowires, and ZnO nanoarrays will also be etched in step D and thus yield nanoporcupines with a ZnO stem that is a nanoneedle.

Similarly, ZnO microrods and microneedles will also be etched in step D and yield nanoporcupines with a ZnO stem that is a microneedle.

ZnO nanotubes will be etched in step D and will yield nanoporcupines with a ZnO stem that is a nanotube. Indeed, while the etching may somewhat change the ends the nanotubes walls, for all intents and purposes, they will still be nanotubes.

In preferred embodiments, the ZnO stem precursors are ZnO nanorods. Preferred methods of manufacturing ZnO nanorods are described in the next section.

The ZnO stem precursors of step A can be manufactured according to any method known in the art.

For example, microrods are produced in the same ways as nanorods (see next section), except that a non-seeded substrate or a GaN seed layer are used.

There are two ways of growing ZnO nanowires:
chemically assisted growth such as growth assisted with polyethyleneimine, for example as described in Chen et al, J. Phys. Chem. C 2011, 115, 43, 20913-20919, incorporated herein by reference, and
Using the same method as for growing nanorods and renewing the same growth solution for two or three times, for example as described in Canlin et al., ACS Appl. Mater. Interfaces 2016, 8, 22, 13678-13683, incorporated herein by reference.

Nanotube preparation is done in two steps: first synthesizing nanorods or microrods as described hereinbelow. Second, etch the inner side of the nanorods or microrods a using basic solution to make them hollow so as to produce the nano/microtube. See for example Elias et al., Chem. Mater. 2008, 20, 21, 6633-6637, incorporated herein by reference.

Nanoarrays are basically the same nanorods with the emphasize that they are perpendicular to the surface. Therefore, they are mostly grown like nanorods.

Nanoneedles and microneedles are produced from nanorods and microrods, respectively. They can be produced by placing nanorods/microrods in similarly to that used to grow the nanorods/microrods except that it further contains polyethyleneimine.

In preferred embodiments, the zinc salt is zinc nitrate, zinc acetate, zinc chlorate, or zinc sulfate, preferably zinc nitrate and/or zinc acetate.

In preferred embodiments, the reaction mixture has a zinc salt concentration of about 0.1 mM to about 5 mM, preferably from about 0.1 mM to about 1 mM, more preferably of about 0.7 mM.

In preferred embodiments, the reaction mixture has a hexamethylenetetramine concentration of about 0.1 mM to about 1 mM, preferably from about 0.1 mM to about 1 mM, more preferably of about 0.7 mM.

In preferred embodiments, the HMTA:zinc salt weight ratio is from about 1:3 to about 3:1, preferably about 1:1.

In preferred embodiments, the reaction mixture has a L-ascorbic acid concentration of about 0.1 mM to about 1 mM, preferably from about 0.1 mM to about 0.7 mM, more preferably of about 0.4 mM.

In preferred embodiments, step B comprises the step of providing a solution of the zinc salt and the L-ascorbic acid in deionized water and then adding the hexamethylenetetramine to the solution of the zinc salt and the L-ascorbic acid.

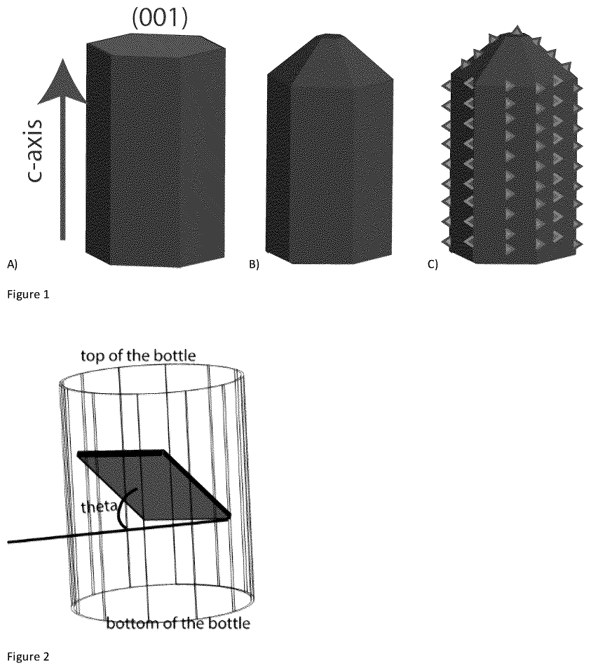

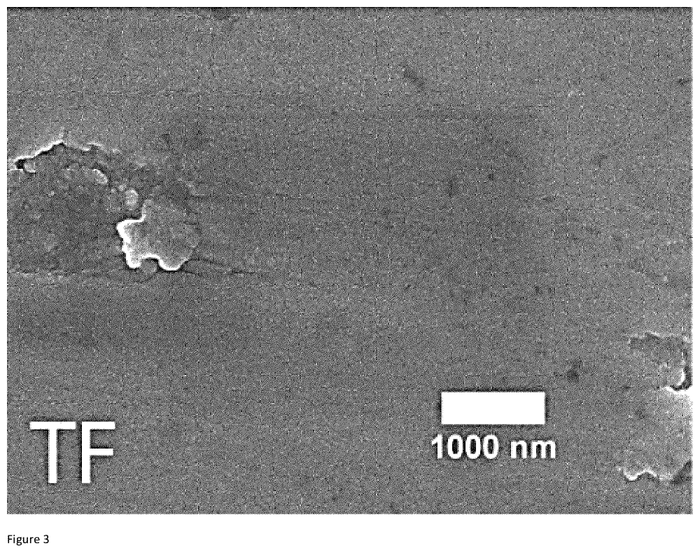

In preferred embodiments, during steps C and D, the surface lies mid-water in the reaction container. Herein, the expression “mid-water” has its regular meaning: the middle portion vertically of a body of water i.e., substantially below the surface and substantially above the bottom. In preferred embodiments, the surface on which the ZnO stem precursors are to be grown faces the bottom of the reaction container. In preferred embodiments, the surface on which the ZnO stem precursors are to be grown is at an angle Θ from the bottom of the reaction contained. In more preferred embodiment, this angle Θ is between 0° and 90°, preferably at about 45°. FIG. 2 shows the most preferred position of the surface on which the nanospikes are to be grown in the reaction container.

In preferred embodiments, in step E), the reaction mixture is heated of about 90° C. The heating can be provided by a furnace, a hot plate (warm bath), or a microwave oven. In preferred embodiments, in step E), the reaction mixture is heated for about 2 to about 8 hours, preferably for about 4 h e.g., in a furnace.

### Providing the Nanorods

The ZnO nanorods can be manufactured according to any method known in the art. In preferred embodiments, step i comprises manufacturing the ZnO nanorods by:
STEP 1) optionally, depositing a seed layer on the surface of the substrate to allow the growth of ZnO nanorods on the surface, and
STEP 2) growing the ZnO nanorods on the surface of the substrate.

### Seed Layer

Depending on the nature of the surface of the substrate a seed layer may or may not be necessary. In preferred embodiments, step 1) is carried out.

Using a seed layer, allows growing nanorods on surface of different nature and texture.

However, in alternative embodiments, step 1) is not carried out. In preferred such embodiments, the surface of the substrate is made of ZnO, indium tin oxide (ITO) glass or of fluorine-doped tin oxide (FTO) glass. These glasses are two of the commonly used substrates for energy conversion applications. More importantly, these two substrates do not need any seed layer to allow the growth of the ZnO nanorods.

Other substrates typically require a seed layer, which allows growing ZnO nanorods that are densely packed as described above. Without such seed layer, in most cases, the ZnO nanorods would not grow or grow randomly, sparsely, very inclined rather than extending away from the surface, or form microrods.

In preferred embodiments, the seed layer is:
a GaN layer (typically yielding large rods, even microrods),
a zinc oxide layer, or
an annealed zinc layer,
preferably a layer of ZnO nanoparticles.

In embodiments the seed layer is a GaN layer. Therefore, in such embodiments, step 1) comprises the step of depositing a GaN layer on the surface of the substrate. Such gallium nitride (GaN) layer has a wurtzite crystal structure similar to that of ZnO. Therefore, covering a surface with a GaN layer promotes the nucleation of ZnO nanorods. The nanorods grown on this layer have typically larger diameters and are fully perpendicular to the surface. However, this layer typically requires a sacrificial layer between the GaN and the surface of the substrate (except when the substrate is sapphire).

In embodiments the seed layer is a zinc oxide layer. Therefore, in such embodiments, step 1) comprises the step of depositing a zinc oxide layer on the surface of the substrate. The zinc oxide layer often requires a sacrificial layer between the seed layer and the surface of the substrate to promote its adherence to the substrate and compensate for the crystal mismatching.

In embodiments the seed layer is an annealed zinc layer. Therefore, in such embodiments, step 1) comprises the step of depositing a zinc layer on the surface of the substrate and annealing the zinc layer so it transforms into ZnO. In embodiments, the annealing is carried out at about 200° C. or more for about 10 or more minutes. This seed layer also often requires a sacrificial layer between the seed layer and the surface of the substrate to promote its adherence to the substrate.

The GaN, zinc, and zinc oxide layers can be deposited by any method known to the skilled person. Such methods include chemical vapor deposition (CVD) methods such as thermally activated CVD, plasma enhanced CVD, photo-assisted CVD, and metal organic CVD, as well as physical vapor deposition methods including:
thermal processes such as thermal deposition, electron beam deposition, molecular beam epitaxy deposition, and pulsed layer deposition, and
a thermal processes such as direct current diode sputtering, radio frequency sputtering, magnetron sputtering, and unbalanced magnetron sputtering.

The GaN seed layer is typically deposited by chemical vapor deposition or other physical deposition methods that requires high temperature and/or harsh deposition conditions.

In preferred embodiments, the seed layer is a layer of ZnO nanoparticles.

In preferred such embodiments, step 1) comprises the steps of
STEP 1′) depositing a zinc salt layer on the surface of the substrate and
STEP 1″) annealing the zinc salt layer, thus producing a layer of ZnO nanoparticles.

This method relies on a chemical synthesis of the ZnO nanoparticles. In preferred embodiments, step 1′) comprises the steps of providing a solution of the zinc salt in a volatile solvent, depositing the solution on the surface of the substrate, and allowing the solvent to evaporate. In embodiments, the zinc salt is zinc nitrate, zinc acetate, zinc chlorate, or zinc sulfate, preferably zinc nitrate or and zinc acetate. In preferred embodiments, the volatile solvent is an alcohol (such as ethanol, methanol, isopropanol, and the like), or acetone. In preferred embodiments, the solvent preferably has a low evaporation temperature (preferably from about 30° C. to about 82° C.) and low surface tension index (preferably from about 22 mN/m to about 25 mN/m). The zinc salt concentration in the solution is not particularly limited and can be as high as the saturation point. In embodiments, the solution is deposited on the surface of the substrate by drop casting, spin coating, dip coating, spray coating, inkjet printing, or another similar method. The annealing transforms the zinc salt layer into a ZnO layer. In preferred embodiments, in step 1″), the annealing is carried out at a temperature of at least about 200° C. for at least about 10 minutes. In embodiments, the method further comprises the step 1′″ of repeating step 1′ followed by step 1″ one or more times.

In alternative embodiments, step 1) comprises the steps of:
STEP 1a) providing a solution of the zinc salt in a volatile solvent,
STEP 1b) providing a solution of an oxidant in a volatile solvent,
STEP 1c) combining the solution of the zinc salt and the solution of the oxidant to form a reaction mixture,
STEP 1d) allowing the ZnO nanoparticles to form, and
STEP 1e) depositing the reaction mixture on the surface of the substrate, thus producing the layer of ZnO nanoparticles.

This method also relies on a chemical synthesis of the ZnO nanoparticles. In embodiments, the zinc salt is zinc nitrate, zinc acetate, zinc chlorate, or zinc sulfate, preferably zinc nitrate or and zinc acetate. The zinc salt concentration in the solution is not particularly limited and can be as high as the saturation point. In embodiments, the oxidant is NaOH, KOH, or LiOH, preferably at a concentration matching the concentration of the zinc salt or higher. In preferred embodiments, the volatile solvent (for either or both, preferably both, the zinc salt and the oxidant) is an alcohol. In more preferred embodiments, the solvent for the zinc salt is the same as the solvent for the oxidant. At step 1c), the solution of the oxidant should be added slowly to the solution of the zinc salt. Also, at step 1d), the reaction mixture should be stirred until the oxidation complete. In preferred embodiments, in step 1e), the reaction mixture is deposited on the surface of the substrate by drop casting, spin coating, dip coating, spray coating, inkjet printing, or another similar method. In embodiments, the method further comprises the step 1f of repeating step 1e) one or more times.

In other alternative embodiments, step 1) comprises the steps of
STEP 1i) providing a first solution comprising the zinc salt and one or more surfactants in a volatile solvent,
STEP 1ii) heating the first solution of the zinc salt to produce a second solution comprising ZnO nanoparticles, and
STEP 1iii) depositing the second solution on the surface of the substrate, thus producing the layer of ZnO nanoparticles.

This method again relies on a chemical synthesis of the ZnO nanoparticles. In embodiments, the zinc salt is zinc nitrate, zinc acetate, zinc chlorate, or zinc sulfate, preferably zinc nitrate or and zinc acetate. The zinc salt concentration in the solution is not particularly limited and can be as high as the saturation point. In preferred embodiments, the volatile solvent is an alcohol. In preferred embodiments, at step 1ii), the first solution is heated at about 60° C. to about 90° C. for about 30 mins to about 10 h, preferably at 60° C. for about 2 h. In preferred embodiments, in step 1iii), the second solution is deposited on the surface of the substrate by drop casting, spin coating, dip coating, spray coating, inkjet printing, or another similar method. In embodiments, the method further comprises the step liv of repeating step 1iii) one or more times.

The one or more surfactants can be organic surfactant such as kale leaves, aloe vera, orange peel, etc.

### Growing the Nanorods

The nanorods can be grown by any method, including for example, that described in Gyu-Chul Yi et al., ZnO nanorods: synthesis, characterization and applications, 2005 Semicond. Sci. Technol. 20 S22, incorporated herein by reference. Alternatively, they can be grown by a sonochemical method where a zinc plate together with an oxidant are exposed to sonication.

The hydrothermal synthesis of ZnO nanorods is the most common method used for producing ZnO nanorods, which is discussed below.

In preferred embodiments, step 2) comprises the steps of
STEP 2a) providing a reaction mixture in a reaction container, wherein the reaction mixture comprises a zinc salt and a source of hydroxide ions in deionized water,
STEP 2b) immersing the surface on which the nanorods are to be grown (preferably bearing a seed layer) in the reaction mixture, and
STEP 2c) heating the reaction mixture with the surface immersed therein, to produce the ZnO nanorods.

In embodiments, the zinc salt is zinc nitrate, zinc acetate, zinc chlorate, or zinc sulfate, preferably zinc nitrate or and zinc acetate.

In embodiments, the source of hydroxide ions is an alkaline metal hydroxide (such as NaOH, KOH, LiOH, etc.) or by hexamethylenetetramine (HMTA). When alkaline metal hydroxides are used, the step 2a) further comprises adjusting the pH of the reaction mixture from about 6 to about 10, preferably at about 9. This is not necessary for HMTA as it gradually release the OH ions during step 2c).

The physical properties of the nanorods can be adjusted by modifying the concentration of the zinc salt, the concentration of the source of hydroxide ions as well the temperature to which the mixture is heated during step 2c). When smaller concentrations are used, the nanorods are shorter and sparser. When larger concentrations are used, the nanorods are larger and denser, and eventually nanoparticles side product will precipitate at the bottom of the bottle.

In embodiments, the reaction mixture has a zinc salt concentration of about 0.1 mM to about the saturation point, preferably of about 1 mM to about 100 mM, more preferably of about 25 mM.

In embodiments, the reaction mixture has a source of hydroxide ions concentration of about 0.1 mM to about the saturation point, preferably of about 1 mM to about 100 mM, preferably of about 25 mM.

In embodiments in which HMTA is used, the HMTA:zinc salt weight ratio is preferably from about 1:3 to about 3:1, more preferably about 1:1.

In preferred embodiments, during steps 2b) and 2c), the surface lies mid-water in the reaction container. In preferred embodiments, the surface on which the nanorods are to be grown faces the bottom of the reaction container. In preferred embodiments, the surface on which the nanorods are to be grown is at an angle Θ from the bottom of the reaction contained. In more preferred embodiment, this angle Θ is between 0° and 90°, preferably at about 45°. FIG. 1 shows the most preferred position of the surface on which the nanorods are to be grown in the reaction container.

In preferred embodiments, in step 2c), the reaction mixture is heated at a temperature between about 60° C. and about 95° C., preferably at a temperature of about 90° C. The heating can be provided by a furnace, a hot plate (warm bath), or a microwave oven. In preferred embodiments, in step 2c), the reaction mixture is heated for about 30 mins to about 12 hours, preferably for about 4 h.

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted. In contrast, the phrase “consisting of” excludes any unspecified element, step, ingredient, or the like. The phrase “consisting essentially of” limits the scope to the specified materials or steps and those that do not materially affect the basic and novel characteristic(s) of the invention.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

Other objects, advantages and features of the present invention will become more apparent upon reading of the following non-restrictive description of specific embodiments thereof, given by way of example only with reference to the accompanying drawings.

### DESCRIPTION OF ILLUSTRATIVE EMBODIMENTS

The present invention is illustrated in further details by the following non-limiting examples.

### Example 1—Nanostructured Zinc Oxide Surface Coatings for Bacterial Growth Inhibition

This study reports a series of ZnO nanostructured coatings that exhibit bactericidal properties towards Gram-positive (S. aureus) and Gram-negative bacteria (K. pneumonia). The physical properties and hydrophilicity of coatings composed of arrays of one-dimensional (1D) nanostructures were investigated. The results show that the antibacterial activity of the coatings mainly depends on hydrophilicity. In this regard, ZnO nanorods and nanoneedles were more hydrophilic and more effective against the bacteria in a humid environment, which makes them an ideal choice for applications where the contaminated surfaces remain wet. Nano-porcupines, on the other hand, show competitive antibacterial performance under drier conditions, where droplets of contaminated water may dry faster.

The three main factors that need to be considered when developing a bactericidal coating are performance, fabrication cost, and durability. Smooth metal or metal oxide thin films (TFs) represent the most basic type of antibacterial coatings and are most applicable to small surfaces. The cost of depositing TFs by common physical techniques rises exponentially with the size of the device that needs to be covered, and they have lower bactericidal performance compared to the other structures with higher surface-to-volume ratios.

Indeed, nanostructured coatings tend to have better antibacterial properties because increased surface area promotes contact with the bacteria [13]. This, for example, is evidenced by the fact that the antibacterial activity of ZnO nanoparticles increases with size reduction [14, 15].

However, one major challenge in developing nanostructured coatings is to anchor them to the surface of an object to maintain their performance after a long period of use. In this regard, arrays of one-dimensional nanostructures such as nanorods (NR), nanowires, and nano-pillars are nanoscale topologies that strongly attach to surfaces while maintaining significantly higher surface-to-volume ratios than TFs, as well as higher antibacterial properties than nanoparticles.

Immobilized perpendicular arrays of nano-pillars mimic the natural bactericidal activity of dragonfly wings [16].

In our view, perpendicular arrays of metal oxide NRs are among the best candidates for permanent antibacterial surface coatings due to their physical and chemical stability against everyday wear and tear. They are more effective/affordable/accessible compared to traditional antibacterial coating materials such as gold and silver.

These nanostructures have intrinsic antibacterial properties by physically damaging bacteria in addition to other mechanisms (e.g., generation of bactericidal chemical species upon light irradiation) making them ideal candidates for use in dark conditions [17]. Of all inorganic metal oxide nanomaterials, zinc oxide (ZnO) stands out to us due to its facile synthesis protocol and excellent properties [18, 19, 20]. The application of ZnO nanomaterials is not limited to their antibacterial properties, as their antifungal, anti-cancer, and wound healing properties have also been demonstrated in vitro [15, 21-23]. Micron-sized and larger ZnO ceramics are generally recognized as safe substances by the US FDA. In addition, ZnO nanostructures have the potential to inhibit the growth of a mature biofilm and reduce the bacterial viability [24, 25].

Chemically prepared ZnO NR coatings are known to be durable in harsh working conditions; NRs usually have a hexagonal flat top with diameters in the range of 50 to 1000 nanometers, and possess antibacterial properties [20]. Their hydrothermal manufacture requires reasonably mild conditions (e.g., a neutral aqueous medium at temperatures as low as 60° C.), and it is adaptable to almost any surface [26];

This study explores adaptations to an existing synthetic procedure to alter the nanoscale topology of coatings beyond the NR towards nano-needles (NN) and nano-porcupine (NP) topologies, and explores the influence of this on bactericidal properties. This study also investigates the influence of such nanoscale topologies on the resulting antibacterial properties of the coating in environments of different humidity (i.e., contaminated droplets allowed to dry or not).

### Materials and Methods

### Materials

304 stainless steel (S.S.) mirror-like sheets with a thickness of 0.005 inches were purchased from McMaster-Carr supply Company. Zinc acetate dehydrate, hexamethylenetetramine, and L-ascorbic acid were purchased from Sigma-Aldrich. Zinc nitrate hexahydrate was purchased from Fisher Chemical Company and polyethyleneimine (50% aqueous solution) was obtained from MP biomedicals. All chemicals were purchased at the highest purity available and used as received.

### Seeding of ZnO

The S.S. substrates were cleaned via successive sonication in acetone, ethanol, and nanopure water for 10 minutes each, and dried under a flow of nitrogen. To produce a coating densely populated with NRs, the substrate first needed to be seeded with ZnO nanoparticles (known as a seeding layer). Accordingly, 5 mL zinc acetate in ethanol (5 mM) was drop-cast onto a 5×2 cm² S.S. substrate for 1 to 7 times, dried under the flow of nitrogen after each casting and then annealed within the temperature range of 300° C. for 30 minutes. The seeding process was repeated twice to enhance the nanoparticle coverage over the substrate.

### Growth of Nanostructured Films

To grow NRs, the seeded substrate was submerged in a growth solution, which contained an equimolar mixture of zinc nitrate and hexamethylenetetramine (HMTA) at 25 mM. The growth solution was heated at 90° C. for 4 hours.

For growing NNs (i.e., NRs with sharp tips), the flat top NRs coating was left in a growth solution containing 1.33 mL of a 12.5% polyethyleneimine (PEI) solution in water, and zinc nitrate and HMTA with the concentration of 25 mM.

In order to fabricate NPs, S.S. substrates coated with ZnO NRs were submerged in an aqueous solution containing an equimolar zinc nitrate and HMTA with a molarity of 0.75 mM, as well as 0.4 mM L-ascorbic acid. The growth was done in 4 hours at 90° C. L-ascorbic acid does not participate in the crystal and thus the NPs are solely composed of ZnO. All samples were washed with deionized water at the end of each hydrothermal growth step and air-dried for further characterization.

A thin film (TF) of ZnO was also deposited on the S.S. substrate by magnetron sputtering using a ZnO target. The chamber pressure was adjusted at 6 mTorr with the injection of argon and oxygen. The deposition was done in 3 hours at 20 W.

### Surface Characterization

The surface morphology of each sample was visualized with a JEOL 7100 scanning electron microscope (SEM).

The precise geometry and crystal structure of the NPs were measured by high-resolution transmission electron microscopy (HRTEM, JEOL JEM-2100F).

The elemental analysis of the samples was characterized with a Quantax 100 Energy-dispersive X-ray spectroscopy (EDS) system attached to a Vega 3 SEM.

The crystallinity of the samples was analyzed using a Bruker D8 Advance X-ray diffractometer (XRD) operating at 40 kV and 40 mA using Ni-filtered Cu K_{α} irradiation (wavelength 1.5406 Å) in the range of 20-70° with the 0.02° step size.

The surface chemical composition of the samples was analyzed with an Escalab 220 I X-ray photoelectron spectroscopy (XPS) system in polychromatic mode with Al K_{α} radiation. Charge calibration was done by setting the C 1 s line of adventitious carbon to 285 eV to compensate for charge effects.

Room temperature photoluminescence (PL) spectra were collected in the range of 370-635 nm while the samples were excited at 340 nm.

Contact angle measurements were performed by drop-casting 5 μL of deionized water at four different locations of each sample and the averages were reported.

### Antibacterial Activity Assay

A Gram-positive bacterium, Staphylococcus aureus strain Newman and a Gram-negative bacterium, Klebsiella pneumoniae ATCC 4352, were used for antibacterial activity assays. Cultures of each bacterium were prepared in Tryptic Soy Broth (TSB, Difco) and grown for 20 h at 37° C. in a roller drum (New Brunswick). Then, cultures were diluted at 1:100 in TSB and grown to reach an optical density at 600 nm (OD₆₀₀) of 0.5. Cells were then harvested by centrifugation (10,000×g) for 1 min and washed twice with sterile water. The pellet was then suspended in the same volume of water. Five microliters of the bacterial suspension were deposited on the surface of a coated coupon (5×10 mm), cut with scissors from the original 5×2 cm² coated S.S. substrate. Bare S.S. coupons were used as controls. The coupons topped with bacteria were kept at room temperature for 1 h in sterile Petri dishes. For some experiments, the Petri dishes containing the coupons were placed in a sealed bag containing wet paper towels in order to maintain 100% atmospheric humidity during the assay. After the 1 h contact time, each coupon was placed in 500 μL of phosphate-buffered saline (PBS) containing 0.04% Tween 80 and vortexed for 5 min to remove the bacteria from the surfaces. To measure the initial concentration of bacteria in the suspension (t=0), 5 μL of the initial suspension was added to 500 μL PBS containing 0.04% Tween 80. All suspensions were serially diluted in 0.8% NaCl buffer and 10 μL of each dilution were then deposited to the surface of a Lysogeny Broth (LB) agar plate. The plates were incubated at 37° C. for 24 h. Colonies were counted to calculate the bacterial concentrations (Colony-forming units (CFU) per mL) initially (t=0) and after the 1-hour contact time. Five coupons were used for each experiment. Experiments were repeated at least twice with similar results.

### Results and Discussion

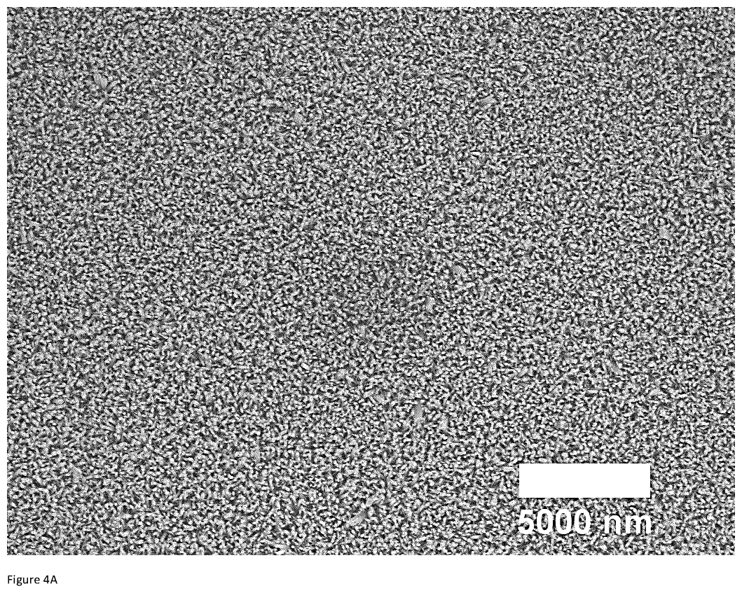

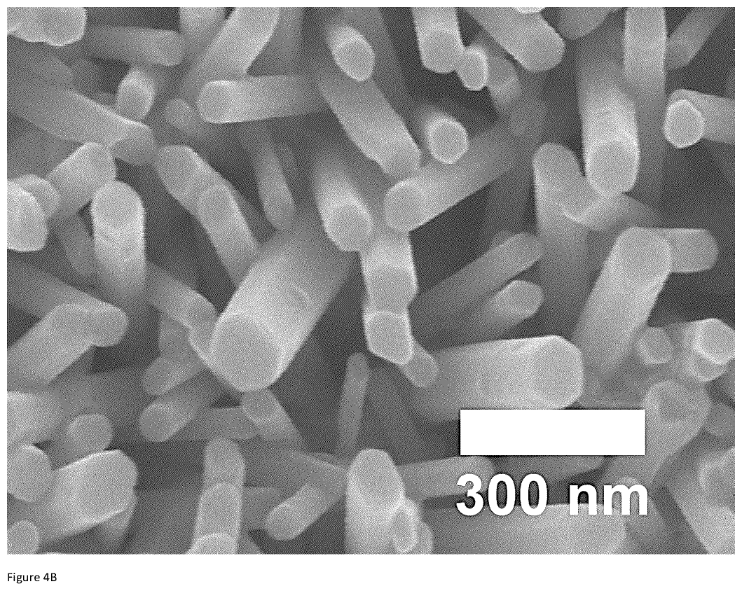

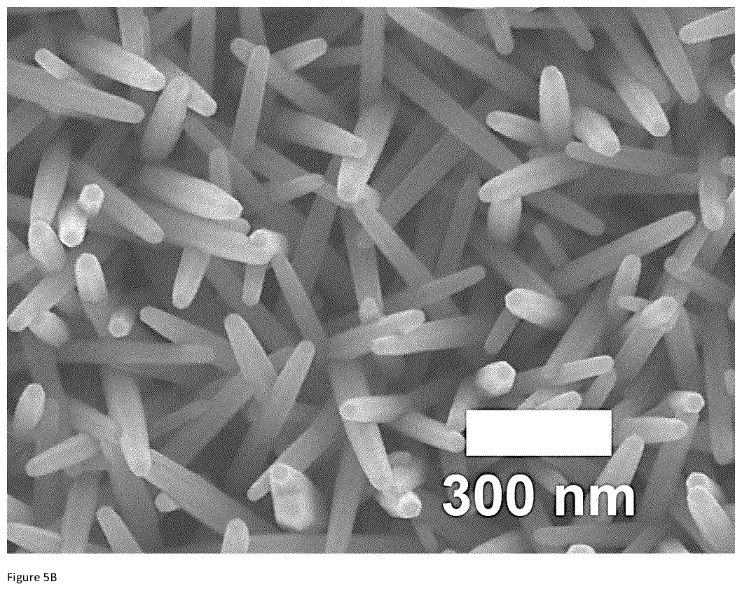

SEM images of the ZnO TF and the nanostructured ZnO coatings are shown in FIGS. 3-6. In all cases the S.S. surface is uniformly covered with ZnO (either film or a blanket of nanostructures). The diameters of flat top NRs are between 50-124 nm, while the NNs taper to the average diameter of ˜30 nm. The flat-top NRs (˜350 nm) are shorter than the NNs (˜650 nm) for two reasons. First, NNs are grown on top of the NRs by means of a second growth step. Second, PEI guides the NRs to grow along the c-axis rather than the cross-section. The difference between the base of the NNs and the tip is roughly 28 nm. As seen in FIG. 6, NPs have sharp tips covered with tiny nanospikes uniformly pointing in all directions. Similar to previous reports [27], the small amount of ascorbic acid in the reaction mixture etches the tips of the NRs, whereas the small amount of growth precursors leads to the appearance of nanospikes. The length of the nanospikes is roughly 15 nm, with a diameter of less than 5 nm according to the SEM image.

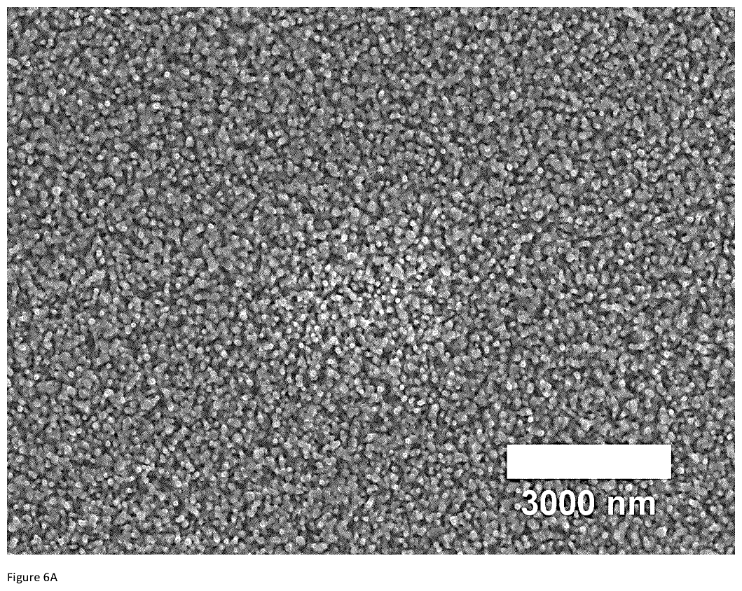

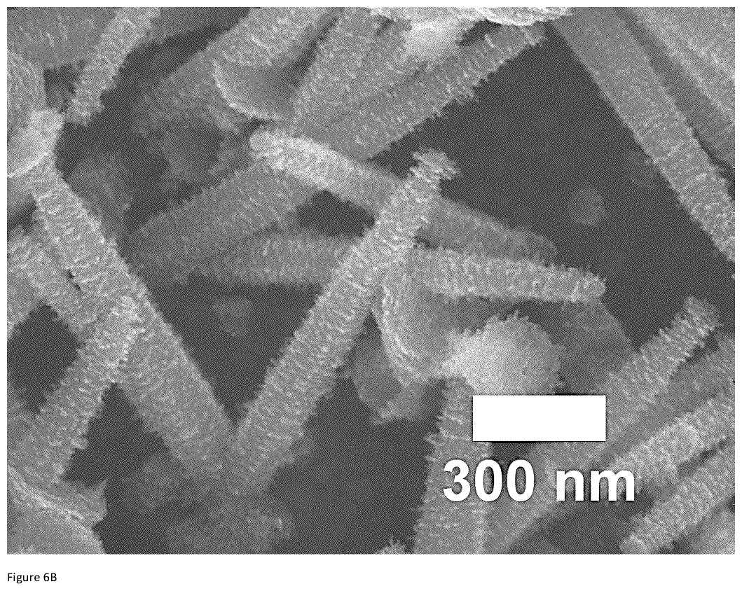

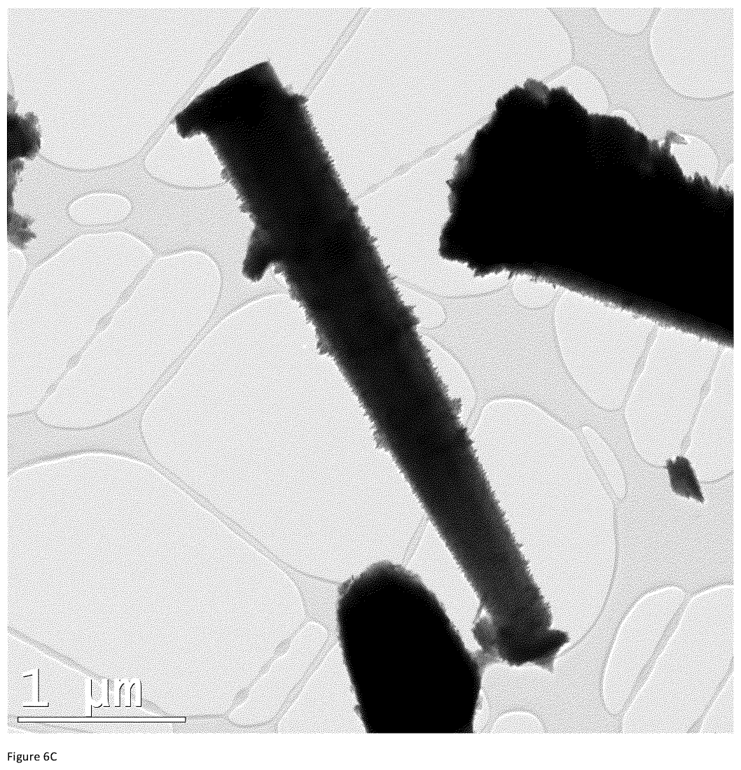

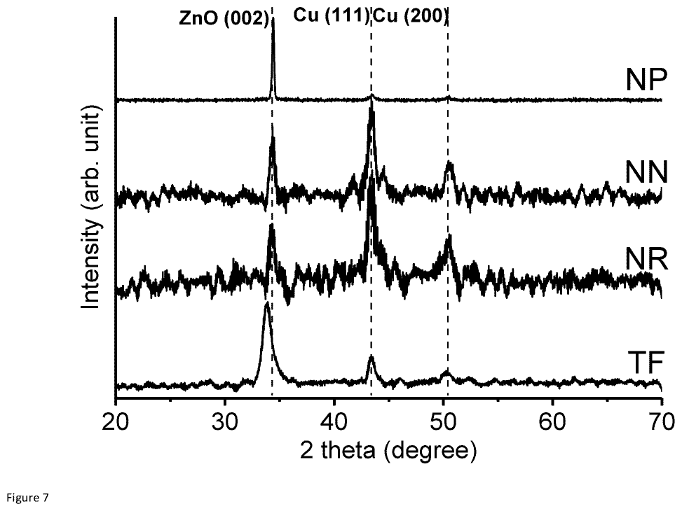

The crystallinity of the samples was investigated by XRD and the resulting diffractograms are shown in FIG. 7. Three main peaks in the patterns are observed at 34.52, 43.42, and 50.42, which are assigned to ZnO (002), Cu (111), and Cu (200) crystal planes, respectively [28]. The former two peaks that appear in the XRD patterns are due to the presence of copper crystals in the S.S. substrate. The first peak, on the other hand, is representative of crystal growth along the c-axis of wurtzite ZnO. The (002) peak of the TF sample occurred at a slightly lower angle (33.92) than for the other nanostructures. Indeed, the flat ZnO TF had a slightly larger lattice constant along the c axis and a larger crystal-plane spacing than the ZnO nanostructures, which likely results from the different methods of preparation. In addition to this difference, the full width at half maximums (FWHMs) of the (002) peaks of the samples are not the same. The TF (002) peak has the highest FWHM (0.872) and the FWHM of the NP is the lowest (0.1742) as compared to the rest of the samples. The FWHM of the NNs and NRs are 0.532 and 0.222, respectively. In the present case, as the NPs are fabricated from NRs, it is thus likely that the lower FWHM (and as a result higher crystallinity) must be related to the sharp tiny nanospikes. This strongly suggests that the nanospikes are crystalline ZnO with a wurtzite crystal structure.

The crystal structure of the NPs was also analyzed by HRTEM and the image is shown in FIG. 8. The nanorod preferentially grows along the c-axis with the lattice constant of c=0.52 nm, which matches the d-spacing measured by XRD. The HRTEM image proves that the nanospikes are purely ZnO wurtzite nanostructure, which grew perpendicular to their c axis with 5 nm and 13 nm in diameter and length, respectively.

PL spectra of the samples are shown in FIG. 9. Two peaks are often recognized in the PL spectra of wurtzite ZnO NRs synthesized by the hydrothermal method [29]. The first peak corresponds to the near band edge emission (NBE) of ZnO crystals and the second broad peak, which falls in the visible region, is known to be related to defect emission. The NBE for the NRs and NNs overlap and are located at 375 nm, while this peak is shifted to 377 nm for the NP. This small shift implies that the nanospikes have a slightly smaller bandgap than the NRs. Thus, nanospikes likely absorb light in the visible range more effectively than the NRs. The NBE peak of the TF is centered at 424 nm showing that it absorbs visible light to a greater extent than the other samples. According to the PL spectra, NNs have the highest defect emission while the TF sample has almost zero-defect emission. NRs and NPs have similar levels of defect emission, conveying the fact that the contribution of the nanospikes to defect emission is negligible.

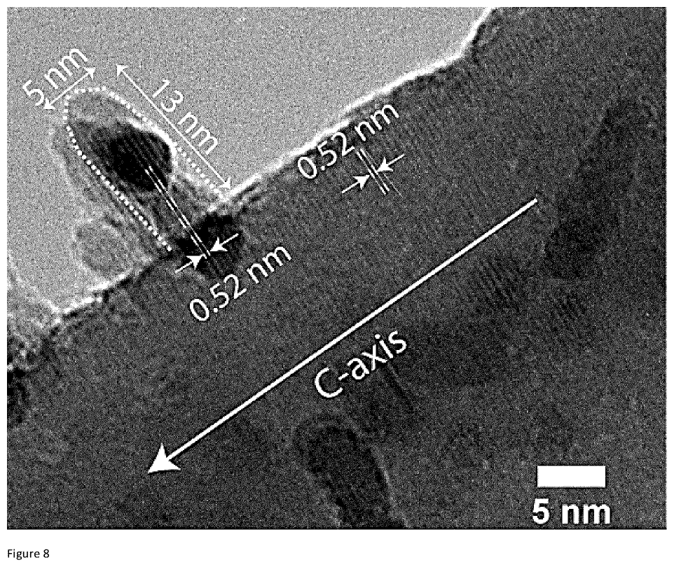

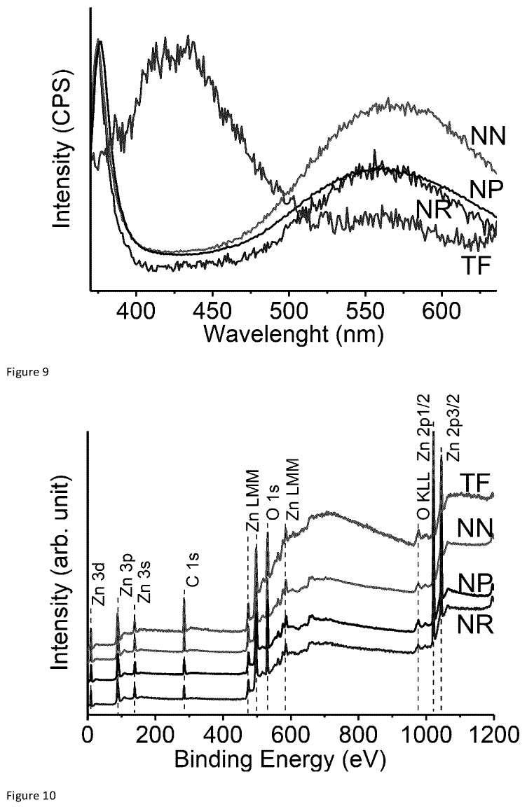

The surface chemical composition of the samples was analyzed by XPS and the spectra are shown in FIG. 10. The peaks at 530.9 eV and 285.8 eV correspond to oxygen and carbon, respectively, which are used for data calibration. The two sharp peaks at 1023.3 and 1044.3 eV are related to Zn 2p 1/2 and Zn 2p 3/2. These peaks are split into due to spin-orbit interactions. The rest of the peaks either arise due to the Auger effect or are connected to electrons in different orbitals of zinc atoms [30]. No other element was detected on the surface of the samples conveying the purity of the ZnO nanostructures prepared by this method.

The high-resolution O 1s peaks of the samples are shown in FIG. 11. The peaks can be decomposed into two sub-spectral components at ˜530 eV and 531.5 eV. The first peak is assigned to O²⁻ ions (O_{L}) in a stoichiometric ratio with Zn²⁺, with their full complement of nearest-neighbor O²⁻ ions. O_{H} is connected with the O²⁻ ions in an oxygen-deficient ZnOₓ region or to hydroxyl groups resulting from chemisorbed water [30]. The shift in O 1s of the TF could be related to stronger Zn—O bonds, as this sample is prepared by a high-energy physical deposition technique rather than by a moderate temperature chemical method.

The surface percentage of each of the sub-peaks was determined by curve fitting and the results are shown in Table 1. Based on these data, the level of lattice oxygen is the lowest for the NP coating. Nevertheless, its O_{H} approximate surface percentage is the highest compared to the other samples. Comparing these results to the defect emission peak of the PL spectrum of the NP sample, it can be concluded that higher OH percentages are related to the larger number of hydroxyl groups at the surface of the NPs.

TABLE 1
Measurement results of deconvolution of O 1 s XPS peaks.

| | | OH approximate |
|---|---|---|
| Sample | OL | surface % |
| TF | 38% | 62% |
| NN | 53.2% | 46.7% |
| NP | 25.47% | 74.53% |
| NR | 58% | 42% |

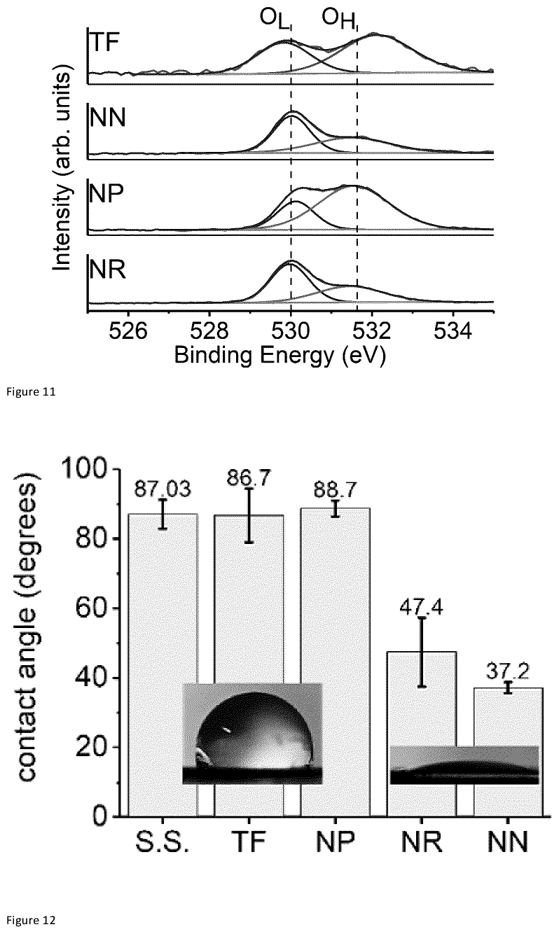

In the course of preliminary experiments, it was observed that water droplets dried at different rates on the different coatings. The contact area of the droplet of bacteria solution is influenced by the hydrophilicity of the surface and the droplet can dry faster on a hydrophilic coating than on a hydrophobic one. The hydrophilicity of the coatings was characterized by the contact angle of a small water droplet (5 μL) on the surface of the samples (FIG. 12). It can be seen that coatings formed by NNs and NRs are much more hydrophilic (>472) than those formed with NPs (882). The greater hydrophilicity of the NRs and NNs is due to the larger voids between the pillars. These voids are filled with nanospikes in the case of the NP topology, which makes it as hydrophobic as a ZnO TF or a S.S. substrate. As an antibacterial coating, this could make it harder for contaminants to stick to the NP coatings compared to the NR and NN coatings. Moreover, surface tension influences the number of bacteria that may have a chance to interact with the nanostructures, which can in turn influence the antibacterial properties of coatings. Previously, it was shown that the antibacterial activity of ZnO nanostructures increases with hydrophilicity [31, 32]. Hydrophilicity was related to the rougher surface and the presence of OH groups on the surface of ZnO nanowire coatings as compared to the ZnO TF. Based on the area of the droplet in contact with the surface, the same number of bacteria interact with one order of the magnitude more rods and needles (5.6×10⁸), than those bacteria sitting on the surface of the NP (5.6×10⁷) sample. This estimation does not include the nanospikes, whose number is difficult to estimate.

Different hydrophilicity becomes a source of complexity when comparing the antibacterial activity of the coatings. Such diverse conditions can be relevant depending on how the coatings are to be used in the real world. Moreover, in practice, a hydrophobic surface could be beneficial since bacterial repellency is more practical than bacterial deactivation.

To explore this scientific question, the antimicrobial assays were performed in either 100% humidity to prevent droplet drying, and in ambient humidity (approx. 50% with no control), which can lead to partial or total drying over the 1-h test time. Comparing these two methods will help to define proper applications for each coating according to their bactericidal performance.

In order to test the antibacterial properties of the coatings, Gram-positive S. aureus and Gram-negative K. pneumonia were chosen, as both are often associated with hospital-acquired infections and antimicrobial resistance [33-35]. In fact, S. aureus and K. pneumonia were among the top six pathogens responsible for 3.57 million deaths associated with antimicrobial resistant in 2019, and they have been identified as priority pathogens by the world health organization [1].

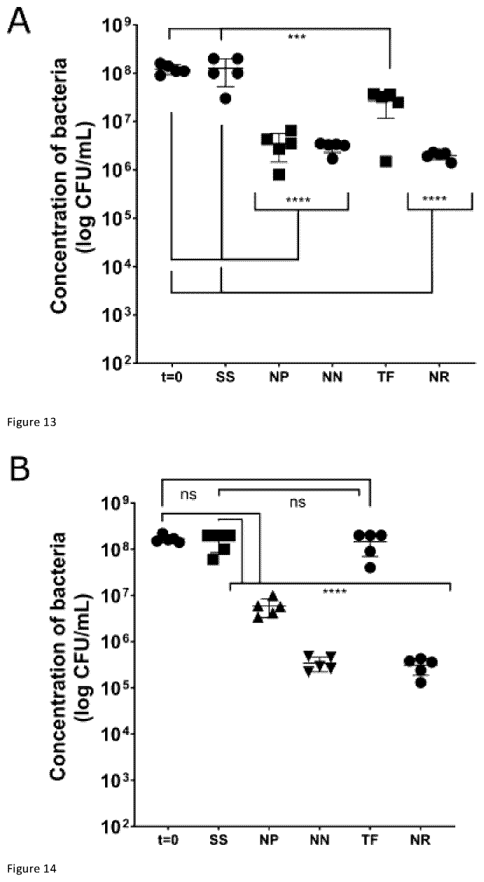

FIG. 13 shows the concentration of live bacteria recovered after 1-h of contact with S. aureus. NP, NR, and NN coatings showed almost two log reduction in the number of live bacteria as compared to the bare S.S. substrate. Amongst the three nanostructured coatings, the one composed of NPs is the most hydrophobic. In ambient humidity, all nanostructured coatings displayed similar antibacterial properties. However, under saturated humidity (FIG. 14), the bactericidal properties of the NP coatings remained at the same level, while the antibacterial performance of the NN and NR coatings improved by as much as an order of magnitude. The bactericidal activity of the coatings in this scenario follows their hydrophilicity (TF<NP<NN<NR), which implies that in a saturated humid environment, hydrophilicity becomes a dominant factor in deciding the antibacterial performance of a coating.

The TF ZnO showed significantly lower bactericidal performance than the NP coating against S. aureus, although they possess almost the same hydrophilicity. This might be an indication of a different bactericidal mechanism of nanostructured ZnO in comparison to the thin film.

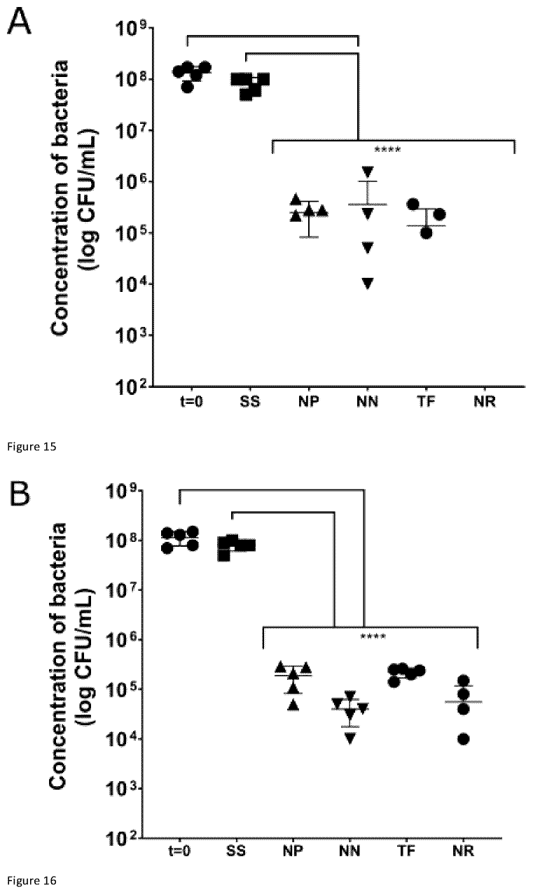

The antibacterial performance of the samples against K. pneumoniae is shown in FIG. 15. The ZnO coatings, independent of their topologies, successfully reduced the number of viable the K. pneumonia bacteria 3 folds in 1 hour period. Similarly, the droplets dried faster in the ambient humidity on NN and NR coatings, causing a significant variation in their bactericidal data (FIG. 16). Similarly, in a saturated humidity environment, the more hydrophilic coatings (NNs and NRs) perform better against K. pneumoniae than NP and TF coatings. The NP and TF coatings' antibacterial performance against K. pneumoniae were almost the same.

Comparing FIGS. 13-16 show that the ZnO coatings are more effective against K. pneumoniae (Gram-negative) than S. aureus (Gram-positive). This finding aligns with a previous report, where the minimum inhibition concentration of ZnO nanotubes dispersion against K. pneumoniae was less than S. aureus [36]. However, this data is in contradiction with many other reports where ZnO powder deactivated Gram-positive bacteria more effectively than Gram-negative bacteria [20, 37]. The key to this contradiction might be related to the physical geometry of the metal oxide antibacterial agent. In reports where the target material was 1D ZnO, in particular when they are immobilized and perpendicular to the surface, the Gram-negative bacteria was deactivated more effectively than the Gram-positive bacteria [38]. This supports the idea that the bacterial damage mechanism strongly depends on the physical geometry of the antibacterial nanostructure element. In other words, ZnO spherical nanoparticles/nanopowders function differently than the nanopillars/wires/rods/tubes against bacteria.

Perpendicular arrays of ZnO NRs, NNs, and NP mimic the natural antibacterial behavior of dragonfly wings [16]. In nature, bacteria attached to these nanopillars experience more stress than when they adhere to a flat surface. The nanopillars rupture the cells once the bacteria touch the wings. Furthermore, it is suggested that the bacteria cell releases an excessive amount of free radicals as a response to its physical confinement, which eventually leads to its death [47]. Theoretical analysis showed that the bactericidal activity of such a coating is a function of the height, shape and density of these nanopillars [39]. It has been shown that higher aspect ratio ZnO nanorods have better antibacterial activity than lower aspect ratio ones [40]. Similarly, the main bactericidal mechanism of the NR, NN, and NP is the physical penetration of these nanostructures into the cell membrane. The bacteria stick to the surface of these 1-dimensional structures via the spread of extracellular polymeric substance, electrostatic attraction, or strong van der Waals forces [16][41]. It should be noted that the bactericidal mechanism of non-immobilized ZnO nanostructures is different from the immobilized arrays of ZnO nanopillars. For instance, the dispersion of ZnO nanorods and nanodisks had almost no effect against a Gram-negative bacteria [41]. Previous reports have shown that the sharp ZnO structure physically disrupted the cell membrane [24, 42][16][20, 25, 43]. It has been observed that the sharp ZnO nanorods in the range of 20-50 nm could penetrate into the bacteria cell [44]. Therefore, we expect a partial penetration of NR and NN with the cost of excessive stress over the bacterial cell membrane. Hence this mechanism is relevant for the coatings presented in this work.

In addition to physically disrupting the cell membrane, the coatings may exert a bactericidal effect by inducing oxidative stress or release of Zn²⁺ cations [44, 46]. ZnO is capable of producing O₂⁻, hydrogen peroxide (H₂O₂), singlet oxygen, and hydroxyl radical (^{•}OH), which are generally known as reactive oxygen species (ROS) [47]. ROS are harmful to the cell membrane, DNA, and cellular proteins. It has been suggested that the presence of these species on the surface of ZnO nano-powder plays a role in its bactericidal properties [47]. The major trigger for the ROS production is light, however, it is claimed, even in the dark, ZnO defects can produce H₂O₂[48]. Hence, the antibacterial performances of ZnO nanorods with and without exposure to light were not much different [49]. The antibacterial activity in the absence of light was not limited to the nanorods, as ZnO nanoparticles have also shown toxicity in dark conditions [50]. It was also suggested that ROS are produced once ZnO contact with bacterial electron carriers [51]. More specifically, the behaviour of the bacteria was observed following penetration of the nanostructure into the cell membrane. This triggered the bacterial natural defensive response, which manifested itself in the form of cell elongation [52]. The second underlying cause behind the fast deactivation of bacteria can be related to the release of Zn²⁺. The presence of Zn²⁺ cations was observed in the vicinity of ZnO nanorods [42]. On the other hand, it is shown that a high level of Zn²⁺ cations in water (25 mg L⁻¹) has no effect on the viability of E. coli or S. aureus and the release of these cations has less than 3% of the role in antibacterial properties of ZnO nanorods [53]. In another report, the authors did not find any correlation between the Zn²⁺ release and antibacterial activity of ZnO nanoparticles [54]. And finally, it has been discussed that the release of Zn²⁺ was not large enough to kill any bacteria [25]. We believe that the release of Zn²⁺ only after internalization can be deadly for the bacterial cell and clarify why the release of cations from the larger particles outside the membrane is ineffective or less effective in the bacteria deactivation.

Gram-positive bacteria have a thicker cell wall than their Gram-negative counterpart, which makes them less susceptible to physical penetration [52]. Moreover, S. aureus are more resistant to oxidative stress. These particularities might explain the differences observed for the two types of bacteria [55]. The other important factor is the shape of these two pathogens [44]. S. aureus is cocci-shaped and K. pneumoniae is rod-shaped. The rod-shaped Gram-negative bacteria are more prone to physical penetration than the spherical cells. It has been shown that nanorods are more lethal against E. coli than B. subtilis, where both bacteria have the same bar shape [25]. The logical conclusion is that if the bacteria have the same shape, the Gram-negative bacteria have lower chances to survive. These differences could contribute to the results observed in this study.

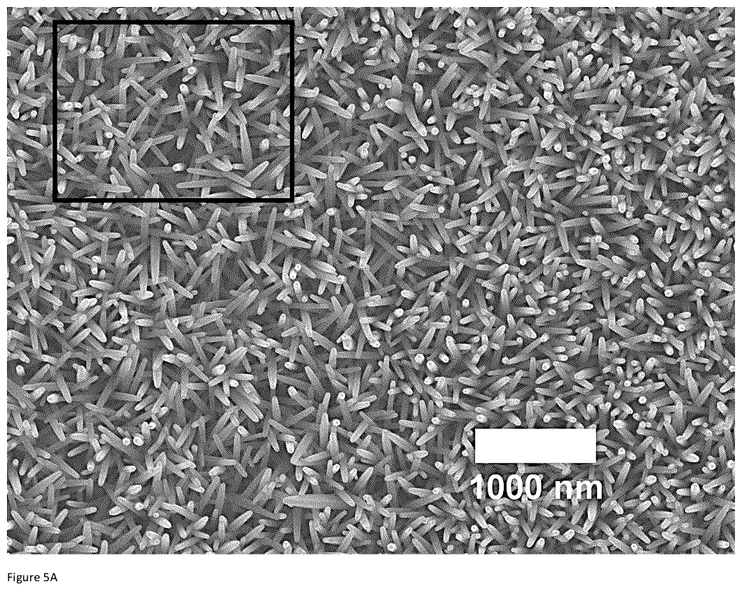

Considering the superior hydrophobicity of the NP and TF ZnO coating, they have considerable antibacterial activity as compared to the hydrophilic NN and NR samples. The surface reactive groups on the NP and TF samples can be one of the main reasons for their comparable antibacterial activity. The higher percentage of O_{H} of the NP and TF samples, as it is shown in FIG. 6(D), provide more chances for electron capture, which may lead to a greater propensity to induce oxidative stress in the bacteria [56]. The other reason behind the superior antibacterial activity of the NP coating, particularly against S. aureus, is the abundant (001) polar surfaces according to the TEM image (FIG. 5). These planes are more active surface in producing ROS [57]. Finally, the positive polar surfaces absorb the negatively charged bacterial membrane more effectively and cause its death.

### CONCLUSION

This study demonstrates that control of the nanoscale morphology of ZnO coatings can be harnessed to manipulate the surface and hence antimicrobial properties. Antibacterial activity assays conducted in a saturated humidity environment showed a negligible effect of nanoscale topology towards K. pneumoniae, but did reveal differences between TF coatings and nanostructured coatings towards S. aureus. The difference in the bactericidal activity of the coatings towards different pathogens is related to the different physical characteristics of the latter. Accordingly, the ZnO coating platform appears versatile and adaptable to different applications, for which specific topologies may present different advantages compared to others. According to the results of these sets of data, the antimicrobial activity of the ZnO nanostructured coatings can be adapted to different situations, such as whether bacterial solutions or aerosols have the potential to dry or not. For example, it might be more appropriate to use NN and NR coatings for surfaces expected to be immersed in water (aquarium wall or sanitary pipes), while NP coatings might be more appropriate for door handles and lift buttons. Future work will require evaluating the robustness of these coatings in the various conditions they are expected to be used.

### Example 2—Coating Other Substrates

Coatings of the invention were produced on glass and silicone substrates using the same process as in Example 1. In fact, coating such substrates is easier than coating stainless steel due to their ultra-smooth surfaces.

The SEM images were very similar to those shown in FIG. 6.

### Comparative Example 1—Using Too Much Ascorbic Acid

Nanoporcupines were not obtained when using 10 mM L-ascorbic acid, together with 25 mM of each of zinc nitrate and of HMTA at 90° C. over a nanorod layer:

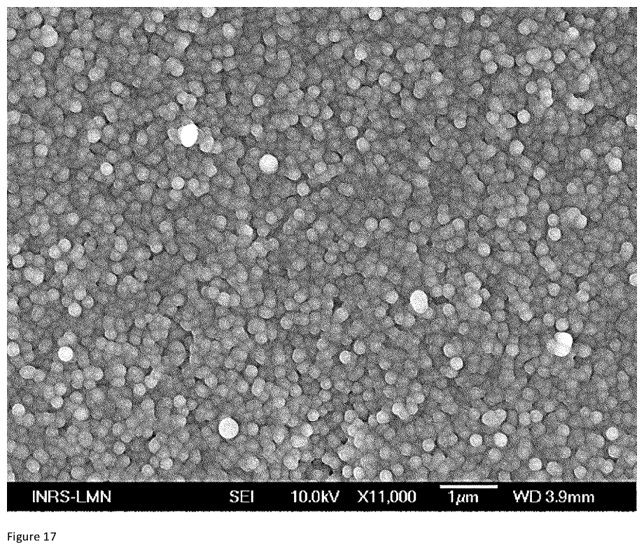

FIG. 17 shows the SEM image of the product obtained.

### Comparative Example 2—Using a Low Temperature

Nanoporcupines were not obtained when using 0.4 mM of L-ascorbic together with 0.7 mM zinc nitrate and 0.7 mM HMTA and heating at 87 C.

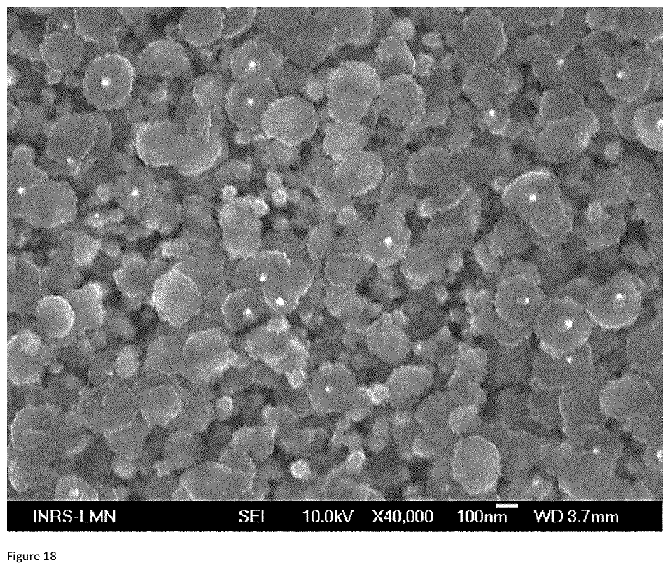

FIG. 18 shows the SEM image of the product obtained.

### Example 3—Endurance and Durability of the Coatings

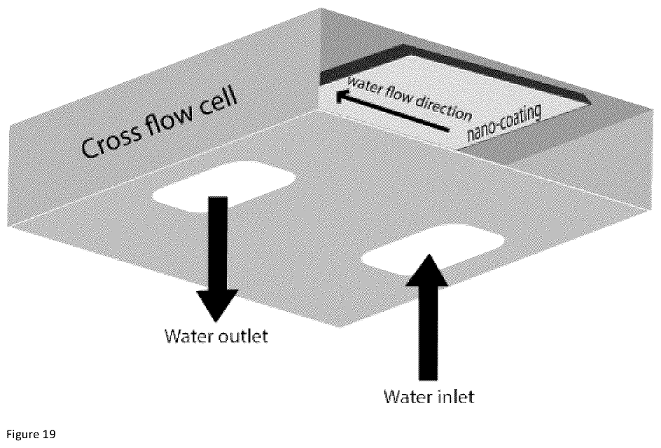

The endurance of performance of the antibacterial coating of Example 1 was tested using a custom-made water cross-flow setup shown in FIG. 19, where the effect of a prolonged tangential water flow on the durability of the ZnO nanoporcupines was studied.

We did not observe any physical damage by naked eye after the test. Thus, we imaged the surface of the nano-coating by SEM to investigate the condition of the nano structures after the cross-flow test.

Our durability test shows the outstanding adherence of our ZnO nano-porcupine coating after being exposed to 6 hours of high-pressure tangential water flow. A schematic diagram of the cross-flow cell which we used in this work is shown below:

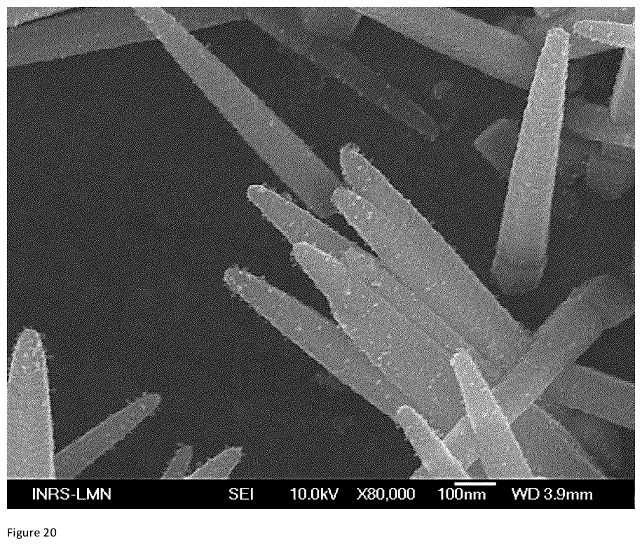

The ZnO nanoporcupine coating was placed in the cross-flow cell facing down towards the water inlet. Tap water (Varennes, QC) with a pH of 7 was used in this test. The pressure of the water inside the cell was adjusted in the range of 10-25 psi with the water flow rate in the range of 0.8 to 1 liter per minute. The test temperature was set to 25° C. using a chiller. The SEM image of the nano-porcupine after 6 hours of test is shown in FIG. 20. The main ZnO body resisted for 6 hours of strong tangential water flow. However, the nanospikes showed some sign of wear.

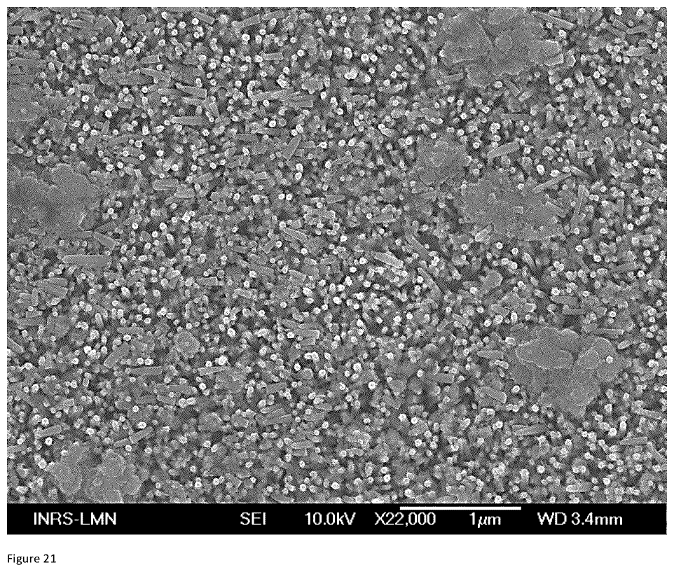

We performed a brush test to verify the durability of the nanoporcupine against physical damage which might happen due to everyday cleaning. We used a normal (medium stiffness) toothbrush for washing the surface of the coating thoroughly with powder soap. The SEM image of the nano-porcupine coating after the brush test is shown FIG. 21. It can be seen that some of the nanorods were decapitated by the brush. However, the majority of the nano-porcupine resisted the moderate brush cleaning.

In conclusion, the ZnO nanoporcupine coating should last a long time of moderate everyday use. There might be some damage to the nanostructures in harsh application conditions as we showed above, such as intense liquid cross flow or brushing. However, none of the above tests fully wiped out of the coating from the surface.

The scope of the claims should not be limited by the preferred embodiments set forth in the examples, but should be given the broadest interpretation consistent with the description as a whole.

### REFERENCES

The present description refers to a number of documents, the content of which is herein incorporated by reference in their entirety. These documents include, but are not limited to, the following:
Document 1. C. J. Murray et al., “Global burden of bacterial antimicrobial resistance in 2019: a systematic analysis,” The Lancet, 2022.
Document 2. J. O'Neill, “Tackling drug-resistant infections globally: final report and recommendations,” 2016.
Document 3. A. Kramer, I. Schwebke, and G. Kampf, “How long do nosocomial pathogens persist on inanimate surfaces? A systematic review,” BMC infectious diseases, vol. 6, no. 1, pp. 1-8, 2006.
Document 4. P. Aranega-Bou, N. Ellaby, M. J. Ellington, and G. Moore, “Migration of Escherichia coli and Klebsiella pneumoniae Carbapenemase (KPC)-Producing Enterobacter cloacae through Wastewater Pipework and Establishment in Hospital Sink Waste Traps in a Laboratory Model System,” Microorganisms, vol. 9, no. 9, p. 1868, 2021.
Document 5. B. W. Buchan et al., “The relevance of sink proximity to toilets on the detection of Klebsiella pneumoniae carbapenemase inside sink drains,” American journal of infection control, vol. 47, no. 1, pp. 98-100, 2019.
Document 6. E. Avershina, V. Shapovalova, and G. Shipulin, “Fighting antibiotic resistance in hospital-acquired infections: current state and emerging technologies in disease prevention, diagnostics and therapy,” Frontiers in microbiology, p. 2044, 2021.
Document 7. E. Tuladhar et al., “Residual viral and bacterial contamination of surfaces after cleaning and disinfection,” vol. 78, no. 21, pp. 7769-7775, 2012.
Document 8. J.-L. Sagripanti and A. J. S. i. Bonifacino, “Cytotoxicity of liquid disinfectants,” vol. 1, no. 1, pp. 3-14, 2000.
Document 9. A. J. J. o. H. i. Russell, “Bacterial resistance to disinfectants: present knowledge and future problems,” vol. 43, pp. S57-S68, 1999.
Document 10. Q. Liu, L. Brookbank, A. Ho, J. Coffey, A. B. Brennan, and C. J. J. P. O. Jones, “Surface texture limits transfer of S. aureus, T4 bacteriophage, influenza B virus and human coronavirus,” vol. 15, no. 12, p. e0244518, 2020.
Document 11. T. Hogen-Esch, M. Pirbazari, V. Ravindran, H. M. Yurdacan, and W. Kim, “High performance membranes for water reclamation using polymeric and nanomaterials,” ed: Google Patents, 2015.
Document 12. US20160312039
Document 13. A. Stanković, S. Dimitrijević, and D. Uskoković, “Influence of size scale and morphology on antibacterial properties of ZnO powders hydrothemally synthesized using different surface stabilizing agents,” Colloids and Surfaces B: Biointerfaces, vol. 102, pp. 21-28, 2013.
Document 14. O. Yamamoto, “Influence of particle size on the antibacterial activity of zinc oxide,” International Journal of Inorganic Materials, vol. 3, no. 7, pp. 643-646, 2001.
Document 15. M. Kaushik et al., “Investigations on the antimicrobial activity and wound healing potential of ZnO nanoparticles,” Applied Surface Science, vol. 479, pp. 1169-1177, 2019.
Document 16. C. D. Bandara et al., “Bactericidal effects of natural nanotopography of dragonfly wing on Escherichia coli,” ACS applied materials & interfaces, vol. 9, no. 8, pp. 6746-6760, 2017.
Document 17. E.-J. Kim et al., “Thorn-like TiO2 nanoarrays with broad spectrum antimicrobial activity through physical puncture and photocatalytic action,” Scientific reports, vol. 9, no. 1, pp. 1-12, 2019.
Document 18. G.-C. Yi, C. Wang, and W. I. Park, “ZnO nanorods: synthesis, characterization and applications,” Semiconductor Science and Technology, vol. 20, no. 4, pp. S22-S34, 2005/03/16 2005.
Document 19. L. Vayssieres and M. Graetzel, “Highly ordered SnO2 nanorod arrays from controlled aqueous growth,” Angewandte Chemie International Edition, vol. 43, no. 28, pp. 3666-3670, 2004.
Document 20. K. Tam et al., “Antibacterial activity of ZnO nanorods prepared by a hydrothermal method,” Thin solid films, vol. 516, no. 18, pp. 6167-6174, 2008.
Document 21. G. Colon, B. C. Ward, and T. J. Webster, “Increased osteoblast and decreased Staphylococcus epidermidis functions on nanophase ZnO and TiO2,” Journal of Biomedical Materials Research Part A: An Official Journal of The Society for Biomaterials, The Japanese Society for Biomaterials, and The Australian Society for Biomaterials and the Korean Society for Biomaterials, vol. 78, no. 3, pp. 595-604, 2006.
Document 22. X. Wang et al., “Antibacterial Properties of Bilayer Biomimetic Nano-ZnO for Dental Implants,” ACS Biomaterials Science & Engineering, vol. 6, no. 4, pp. 1880-1886, 2020.
Document 23. P. Sadhukhan, M. Kundu, S. Rana, R. Kumar, J. Das, and P. C. Sil, “Microwave induced synthesis of ZnO nanorods and their efficacy as a drug carrier with profound anticancer and antibacterial properties,” Toxicology reports, vol. 6, pp. 176-185, 2019.
Document 24. S. S. Patil et al., “Nanostructured microspheres of silver@ zinc oxide: an excellent impeder of bacterial growth and biofilm,” Journal of nanoparticle research, vol. 16, no. 11, p. 2717, 2014.
Document 25. T. O. Okyay, R. K. Bala, H. N. Nguyen, R. Atalay, Y. Bayam, and D. F. Rodrigues,
“Antibacterial properties and mechanisms of toxicity of sonochemically grown ZnO nanorods,” RSC Advances, vol. 5, no. 4, pp. 2568-2575, 2015.
Document 26. L. Vayssieres, “Growth of Arrayed Nanorods and Nanowires of ZnO from Aqueous Solutions,” Advanced Materials, vol. 15, no. 5, pp. 464-466, 2003.
Document 27. Y.-C. Chang, W.-C. Yang, C.-M. Chang, P.-C. Hsu, and L.-J. Chen, “Controlled growth of ZnO nanopagoda arrays with varied lamination and apex angles,” Crystal Growth and Design, vol. 9, no. 7, pp. 3161-3167, 2009.
Document 28. T. Theivasanthi and M. Alagar, “X-ray diffraction studies of copper nanopowder,” arXiv preprint arXiv:1003.6068, 2010.
Document 29. A. Hassanpour, N. Bogdan, J. A. Capobianco, and P. Bianucci, “Hydrothermal selective growth of low aspect ratio isolated ZnO nanorods,” Materials & Design, vol. 119, pp. 464-469, 2017.
Document 30. A. Hassanpour, P. Guo, S. Shen, and P. Bianucci, “The effect of cation doping on the morphology, optical and structural properties of highly oriented wurtzite ZnO-nanorod arrays grown by a hydrothermal method,” Nanotechnology, vol. 28, no. 43, p. 435707, 2017.
Document 31. O. Akhavan, M. Mehrabian, K. Mirabbaszadeh, and R. Azimirad, “Hydrothermal synthesis of ZnO nanorod arrays for photocatalytic inactivation of bacteria,” Journal of Physics D: Applied Physics, vol. 42, no. 22, p. 225305, 2009.
Document 32. M. Zirak, O. Akhavan, O. Moradlou, Y. Nien, and A. Moshfegh, “Vertically aligned ZnO@CdS nanorod heterostructures for visible light photoinactivation of bacteria,” Journal of Alloys and Compounds, vol. 590, pp. 507-513, 2014.
Document 33. L. Tian, Z. Sun, and Z. Zhang, “Antimicrobial resistance of pathogens causing nosocomial bloodstream infection in Hubei Province, China, from 2014 to 2016: a multicenter retrospective study,” BMC public health, vol. 18, no. 1, pp. 1-8, 2018.
Document 34. D. B. Thuy et al., “Colonization with Staphylococcus aureus and Klebsiella pneumoniae causes infections in a Vietnamese intensive care unit,” Microbial genomics, vol. 7, no. 2, 2021.
Document 35. C. N. I. S. Program, “Healthcare-associated infections and antimicrobial resistance in Canadian acute care hospitals, 2014-2018. Can Commun Dis 2020; 46 (5): 99-112,” ed.
Document 36. N. A. Aal, F. Al-Hazmi, A. A. Al-Ghamdi, A. A. Al-Ghamdi, F. EI-Tantawy, and F. Yakuphanoglu, “Novel rapid synthesis of zinc oxide nanotubes via hydrothermal technique and antibacterial properties,” Spectrochimica Acta Part A: Molecular and Biomolecular Spectroscopy, vol. 135, pp. 871-877, 2015.
Document 37. J. Sawai, H. Igarashi, A. Hashimoto, T. Kokugan, and M. Shimizu, “Evaluation of growth inhibitory effect of ceramics powder slurry on bacteria by conductance method,” Journal of chemical engineering of Japan, vol. 28, no. 3, pp. 288-293, 1995.
Document 38. Z. Zhong, Z. Xu, T. Sheng, J. Yao, W. Xing, and Y. Wang, “Unusual air filters with ultrahigh efficiency and antibacterial functionality enabled by ZnO nanorods,” ACS applied materials & interfaces, vol. 7, no. 38, pp. 21538-21544, 2015.
Document 39. X. Li, “Bactericidal mechanism of nanopatterned surfaces,” Physical Chemistry Chemical Physics, vol. 18, no. 2, pp. 1311-1316, 2016.
Document 40. S. Thakur and S. K. Mandal, “Morphology engineering of ZnO nanorod arrays to hierarchical nanoflowers for enhanced photocatalytic activity and antibacterial action against Escherichia coli,” New Journal of Chemistry, vol. 44, no. 27, pp. 11796-11807, 2020.
Document 41. S. F. C. Orou et al., “Antibacterial activity by ZnO nanorods and ZnO nanodisks: A model used to illustrate “Nanotoxicity Threshold”,” Journal of industrial and engineering chemistry, vol. 62, pp. 333-340, 2018.
Document 42. M. Ashraf et al., “Development of antibacterial polyester fabric by growth of ZnO nanorods,” Journal of Engineered Fibers and Fabrics, vol. 9, no. 1, p. 155892501400900103, 2014.
Document 43. M. Ashraf, P. Champagne, C. Campagne, A. Perwuelz, F. Dumont, and A. Leriche, “Study the multi self-cleaning characteristics of ZnO nanorods functionalized polyester fabric,” Journal of Industrial Textiles, vol. 45, no. 6, pp. 1440-1456, 2016.
Document 44. I. Rago et al., “Zinc oxide microrods and nanorods: different antibacterial activity and their mode of action against Gram-positive bacteria,” RSC Advances, vol. 4, no. 99, pp. 56031-56040, 2014.
Document 45. S. Jiang, K. Lin, and M. Cai, “ZnO nanomaterials: current advancements in antibacterial mechanisms and applications,” Frontiers in Chemistry, vol. 8, 2020.
Document 46. Y. Xie, Y. He, P. L. Irwin, T. Jin, and X. Shi, “Antibacterial activity and mechanism of action of zinc oxide nanoparticles against Campylobacter jejuni,” Appl. Environ. Microbiol., vol. 77, no. 7, pp. 2325-2331, 2011.
Document 47. J. Sawai et al., “Detection of active oxygen generated from ceramic powders having antibacterial activity,” Journal of Chemical Engineering of Japan, vol. 29, no. 4, pp. 627-633, 1996.
Document 48. J. M. Wu and W. T. Kao, “Heterojunction Nanowires of Ag x Zn1-x O—ZnO Photocatalytic and Antibacterial Activities under Visible-Light and Dark Conditions,” The Journal of Physical Chemistry C, vol. 119, no. 3, pp. 1433-1441, 2015.
Document 49. H. Bai, Z. Liu, and D. D. Sun, “Hierarchical ZnO/Cu “corn-like” materials with high photodegradation and antibacterial capability under visible light,” Physical Chemistry Chemical Physics, vol. 13, no. 13, pp. 6205-6210, 2011.
Document 50. F. Achouri et al., “ZnO nanorods with high photocatalytic and antibacterial activity under solar light irradiation,” Materials, vol. 11, no. 11, p. 2158, 2018.
Document 51. C. E. Dodd, P. J. Richards, and T. G. Aldsworth, “Suicide through stress: a bacterial response to sub-lethal injury in the food environment,” International journal of food microbiology, vol. 120, no. 1-2, pp. 46-50, 2007.
Document 52. G. Applerot et al., “Enhanced antibacterial activity of nanocrystalline ZnO due to increased ROS-mediated cell injury,” Advanced Functional Materials, vol. 19, no. 6, pp. 842-852, 2009.
Document 53. E. Jeong et al., “Quantitative evaluation of the antibacterial factors of ZnO nanorod arrays under dark conditions: physical and chemical effects on Escherichia coli inactivation,” Science of the Total Environment, vol. 712, p. 136574, 2020.
Document 54. Y. Leung et al., “Antibacterial activity of ZnO nanoparticles with a modified surface under ambient illumination,” Nanotechnology, vol. 23, no. 47, p. 475703, 2012.
Document 55. H.-J. Choi, B.-J. Park, J.-H. Eom, M.-J. Choi, and S.-G. Yoon, “Achieving antifingerprinting and antibacterial effects in smart-phone panel applications using ZnO thin films without a protective layer,” ACS applied materials & interfaces, vol. 8, no. 1, pp. 997-1003, 2016.
Document 56. H. Yang, C. Liu, D. Yang, H. Zhang, and Z. Xi, “Comparative study of cytotoxicity, oxidative stress and genotoxicity induced by four typical nanomaterials: the role of particle size, shape and composition,” Journal of applied Toxicology, vol. 29, no. 1, pp. 69-78, 2009.
Document 57. G.-X. Tong et al., “Polymorphous ZnO complex architectures: selective synthesis, mechanism, surface area and Zn-polar plane-codetermining antibacterial activity,” Journal of Materials Chemistry B, vol. 1, no. 4, pp. 454-463, 2013.
S. H. Ko et al., “Nanoforest of Hydrothermally Grown Hierarchical ZnO Nanowires for a High Efficiency Dye-Sensitized Solar Cell”, Nano Lett. 2011, 11, 666-671.
K. S. Kim, “Polymer-Templated Hydrothermal Growth of Vertically Aligned Single-Crystal ZnO Nanorods and Morphological Transformations Using Structural Polarity”, Adv. Funct. Mater. 2010, 20, 3055-3063.
J. W. Rasmussen, E. Martinez, P. Louka, D. G. Wingett, Zinc oxide nanoparticles for selective destruction of tumor cells and potential for drug delivery applications, Expert opinion on drug delivery, 7 (2010) 1063-1077.
K. Memarzadeh, A. S. Sharili, J. Huang, S. C. Rawlinson, R. P. Allaker, Nanoparticulate zinc oxide as a coating material for orthopedic and dental implants, Journal of Biomedical Materials Research Part A, 103 (2015) 981-989.
Vayssieres, J. Phys. Chem B 2001, 105, 17, 3350.
Green et al., Nano Lett, 2005, 5, 7, 1231.
Gyu-Chul Yi et al., ZnO nanorods: synthesis, characterization and applications, 2005 Semicond. Sci. Technol. 20 S22
Chen et al, J. Phys. Chem. C 2011, 115, 43, 20913-20919
Canlin et al., ACS Appl. Mater. Interfaces 2016, 8, 22, 13678-13683
Elias et al., Chem. Mater. 2008, 20, 21, 6633-6637
CN106860911A
CN107235506A
WO2010036289A2
WO 2018/056904

1. ZnO nanoporcupines comprising:
a ZnO stem, wherein the ZnO stem is an elongated ZnO nanostructure or microstructure, and
a plurality of ZnO nanospikes attached to and extending away from the surface of the stem, the nanospikes being spread along the length and the circumference of the stem.

2.-4. (canceled)

5. The ZnO nanoporcupines of claim 1, wherein the ZnO stem has a wurtzite crystal structure, grown along the longitudinal axis of the ZnO stem.

6. The ZnO nanoporcupines of claim 1, wherein the ZnO stem has a length/diameter ratio of about 120 to about 2, an average length of about 30 nm to about 6 μm, and an average diameter or width of about 20 nm to about 1 μm.

5.-8. (canceled)

9. The ZnO nanoporcupines of claim 1, wherein the ZnO stem has a hexagonal cross-section.

10. The ZnO nanoporcupines of claim 1, wherein the ZnO stem is a ZnO nanoneedle, a ZnO microneedle, or a ZnO nanotube.

11. The ZnO nanoporcupines of claim 1, wherein the ZnO stem is tapered.

12.-13. (canceled)

14. The ZnO nanoporcupines of claim 13, wherein the ZnO stem is a ZnO nanoneedle and wherein the ZnO nanoneedle has an average length of about 50 nm to about 3 μm and an average diameter or width of about 20 nm to about 700 nm.

15.-18. (canceled)

19. The ZnO nanoporcupines of claim 1, wherein the ZnO stem is non-tapered.

20.-22. (canceled)

23. The ZnO nanoporcupines of claim 1, wherein the nanospikes are spread across the whole surface of the nanoneedle.

24. The ZnO nanoporcupines of claim 1, wherein the ZnO nanospikes have a wurtzite crystal structure grown perpendicular to the longitudinal axis of the nanospikes.

25. The ZnO nanoporcupines of claim 1, wherein the nanospikes have a spheroidal cross-section.

26. The ZnO nanoporcupines of claim 1, wherein the nanospikes have an average length at least about 2 times their average diameter, an average length of about 5 nm to about 100 nm, and an average diameter or width of about 2 nm to about 20 nm.

27.-28. (canceled)

29. The ZnO nanoporcupines of claim 1, wherein the nanoporcupines are densely packed on the surface of the substrate, with the spacing between each neighboring nanoporcupine being less than about 5 nm at their base, the base of the nanoporcupine being the point of attachment of the ZnO nanoneedle to the surface.

30. The ZnO nanoporcupines of claim 29, wherein the nanoporcupines are in contact with one another at their base.

31.-35. (canceled)

36. The ZnO nanoporcupines of claim 1, having a contact angle of more than about 55°, as measured by placing a 5 μL water droplet on a coating of the nanoporcupines on a stainless steel substrate.

37. (canceled)

38. A method of conferring antibacterial and/or antiviral properties to a surface, the method comprising the step of attaching the nanoporcupines of claim 1 on said surface.

39.-49. (canceled)

50. A method of producing the nanoporcupine of claim 1, the method comprising the steps of:
A. providing ZnO stem precursors, attached by one end to a surface of a substrate and extending away from said surface, and
B. providing a reaction mixture in a reaction container, wherein the reaction mixture comprises hexamethylenetetramine, up to about 1 mM of L-ascorbic acid, and up to about 1 mM of a zinc salt in deionized water,
C. immersing the surface with the ZnO stem precursors in the reaction mixture, and
D. heating the reaction mixture at a temperature between about 90° C. and about 95° C. to produce the ZnO nanoporcupines on the surface.

51. The method of claim 50, wherein the zinc salt is zinc nitrate, zinc acetate, zinc chlorate, or zinc sulfate, preferably zinc nitrate and/or zinc acetate.

52.-56. (canceled)

57. The method of claim 50, wherein, during steps C and D, the surface lies mid-water in the reaction container.

58. The method of claim 50, wherein the surface on which the ZnO stem are to be grown is at an angle Θ from the bottom of the reaction contained, wherein the angle Θ is between 0° and 90°.

59.-60. (canceled)
